(19) United States
(12) Patent Application Publication
(10) Pub. No.: US 2021/0198465 A1
(43) Pub. Date: Jul. 1, 2021

(54) Roofing Membranes, Compositions, and Methods Of Making The Same

(71) Applicant: COOPER-STANDARD AUTOMOTIVE, INC., Novi, MI (US)

(72) Inventors: Krishnamachari GOPALAN, Troy, MI (US); Gending JI, Canton, MI (US); Amber TUPPER, Westland, MI (US); Jacob James LAFOREST, Milan, MI (US); Hwanman PARK, Wixom, MI (US)

(73) Assignee: COOPER-STANDARD AUTOMOTIVE, INC., Novi, MI (US)

(21) Appl. No.: 17/202,625

(22) Filed: Mar. 16, 2021

Related U.S. Application Data
(63) Continuation-in-part of application No. 15/836,417, filed on Dec. 8, 2017.
(60) Provisional application No. 62/497,959, filed on Dec. 10, 2016.
(60) Provisional application No. 62/497,954, filed on Dec. 10, 2016.

(51) Int. Cl. C08L 23/26; C08L 23/08

(52) U.S. Cl. CPC C08L 23/26; C08L 2205/025; C08L 2205/035; C08L 23/0807

(57) ABSTRACT

A roofing membrane includes (A) about 40 to 75 wt. % silane-crosslinked polyolefin elastomer/plastomer component including a blend of at least three different polyolefin elastomers, each having different melt mass-flow rate (MFR), measured at 190° C. under a 2.16 kg load, in a range of about 3.0 to 25.0 g/10 min, (E) about 1 to 20 wt. % functional filler(s) including a polyolefin; (F) UV/heat stabilizer(s); (G) antioxidant(s); and (H) fire retardant(s), wt. % based on the total weight of the roofing membrane.

### CROSS-REFERENCE TO RELATED APPLICATIONS

This application is a continuation-in-part of U.S. application Ser. No. 15/836,417 filed Dec. 8, 2017 (pending), entitled ROOFING MEMBRANES, COMPOSITIONS, AND METHODS OF MAKING THE SAME, which is a non-provisional application claiming priority under 35 U.S.C. 119(e) to U.S. Provisional Patent Application No. 62/497,959, filed Dec. 10, 2016, entitled “HOSE, COMPOSITION INCLUDING SILANE-GRAFTED POLYOLEFIN, AND PROCESS OF MAKING A HOSE,” (expired) and to U.S. Provisional Patent Application No. 62/497,954 filed Dec. 10, 2016, entitled “WEATHERSTRIP, COMPOSITION INCLUDING SILANE-GRAFTED POLYOLEFIN, AND PROCESS OF MAKING A WEATHERSTRIP,” (expired), all of which are herein incorporated by reference in their entirety.

### FIELD OF THE DISCLOSURE

The present disclosure generally relates to compositions that may be used to form thermoplastic roofing membranes, and more particularly, to silane-grafted polyolefin elastomer compositions used to form thermoplastic roofing membranes and methods for manufacturing these compositions and roofing membranes.

### BACKGROUND OF THE DISCLOSURE

Commercial roofing materials vary from tar-and-gravel roof to metals such as aluminum or corrugated galvanized steel to various rubber materials. The latter are used due to their long-lasting durability and versatility, but also a relatively simple installation and maintenance as well as better weatherability than other typical commercial roof coverings. The synthetic rubber roofing materials include various thermosets and thermoplastics such as thermoplastic polyolefin compounds (TPO), ethylene, propylene, diene terpolymer (EPDM) rubber, and polyvinylchloride (PVC).

### SUMMARY OF THE DISCLOSURE

In one or more embodiments, a roofing membrane is disclosed. The membrane includes (A) about 40 to 75 wt. % silane-crosslinked polyolefin elastomer/plastomer component including a blend of at least three different polyolefin elastomers, each having different melt mass-flow rate (MFR), measured at 190° C. under a 2.16 kg load, in a range of about 3.0 to 25.0 g/10 min. The membrane further includes (E) about 1 to 20 wt. % functional filler(s) including a polyolefin; (F) UV/heat stabilizer(s); (G) antioxidant(s); and (H) fire retardant(s). wt. % based on the total weight of the roofing membrane. The blend of the at least three different polyolefin elastomers may include a first polyolefin, a second polyolefin, and a third polyolefin in a ratio of first polyolefin:second polyolefin:third polyolefin of about 16.2:1:2. The blend of the at least three different polyolefin elastomers may include two different ethylene-octene copolymers. The component A may include different amounts of each one of the at least three different polyolefin elastomers. The component (E) may include polypropylene having MFR in the same range as the polyolefin elastomers of the component (A). The roofing membrane may exhibit a glass transition temperature of from about −75° C. to about −25° C., measured according to differential scanning calorimetry (DSC) using a second heating run at a rate of 5° C./min or 10° C./min. The roofing membrane may exhibit low temperature retraction in a range of about −35 to −29% at TR10, measured according to ISO 2921.

In another embodiment, a roofing membrane is disclosed. The roofing membrane includes a top layer having a thickness t₁ and having a first (A) silane-crosslinked polyolefin elastomer/plastomer component including a blend of at least three polyolefin elastomers, each having different melt mass-flow rate (MFR), measured at 190° C. under a 2.16 kg load. The roofing membrane also includes a bottom layer having a thickness t₂ and having a second (A) silane-crosslinked polyolefin elastomer/plastomer component including a blend of second polyolefin elastomers. The thickness t₂ is greater than the thickness t₁. At least one of the second blend of polyolefin elastomers may be the same elastomer as in the first blend. A ratio of the first silane-crosslinked polyolefin elastomer/plastomer:second silane-crosslinked polyolefin elastomer/plastomer may be about 19:1 to 2:1. The top layer may also include (F) UV/heat stabilizer(s) and both the top and bottom layers may also include (G) antioxidant(s) and (H) fire retardant(s). The top layer may further include titanium dioxide, and the bottom layer may be titanium dioxide-free. The first and second silane-crosslinked polyolefin elastomer/plastomer components may include a same polyolefin, the polyolefin being present in a lower weight percentage in the bottom layer than in the top layer. The first blend may include a first polyolefin, a second polyolefin, and a third polyolefin in a ratio of first polyolefin:second polyolefin:third polyolefin of about 16.2:1:2. The top layer may have a gel content greater than about 70% and the bottom layer may have a gel content between about 50 and 70%.

In an alternative embodiment, a roofing membrane is disclosed. The roofing membrane has a single-ply layer including a silane-crosslinked polyolefin elastomer/plastomer component comprising a blend of ethylene-1-butene copolymer, ethylene propylene copolymer, and ethylene octene copolymer; and one or more UV/heat stabilizer(s), antioxidant(s), and fire retardant(s). The single-ply layer has elongation at break, measured according to ASTM D412, Die C, of about 600 to 930% and heat ageing elongation at break, measured according to the ASTM D573, of about 350 to 700%. A ratio of the ethylene-1-butene copolymer:ethylene propylene copolymer:ethylene octene copolymer may be about 5.4:1:2. The component (A) may include different amounts of the ethylene-1-butene copolymer, ethylene propylene copolymer, and ethylene octene copolymer. The single-ply layer further includes polypropylene having MFR in the same range as at least one of the ethylene-1-butene copolymer, ethylene propylene copolymer, or ethylene octene copolymer. The roofing membrane may have tensile elongation at break, measured according to ASTM D412, Die C testing method, of about 600 to 930%.

### BRIEF DESCRIPTION OF THE DRAWINGS

FIG. 1 is a cross-sectional view of a non-limiting example of a roofing membrane according to some aspects of the present disclosure;

FIG. 2 is a schematic reaction pathway used to produce a silane-crosslinked polyolefin elastomer according to some aspects of the present disclosure;

FIG. 3 is a flow diagram of a method for making a single-ply roofing membrane with a silane-crosslinked polyolefin elastomer using a two-step Sioplas approach according to some aspects of the present disclosure;

FIG. 4A is a schematic cross-sectional view of a reactive twin-screw extruder according to some aspects of the present disclosure;

FIG. 4B is a schematic cross-sectional view of a single-screw extruder according to some aspects of the present disclosure;

FIG. 5 is a flow diagram of a method for making a single-ply roofing membrane with a silane-crosslinked polyolefin elastomer using a one-step Monosil approach according to some aspects of the present disclosure;

FIG. 6 is a schematic cross-sectional view of a reactive single-screw extruder according to some aspects of the present disclosure;

FIG. 7 is a graph illustrating the stress/strain behavior of a silane-crosslinked polyolefin elastomer, according to aspects of the disclosure, as compared to conventional EPDM compounds;

FIG. 8 is a relaxation plot of an example silane-crosslinked polyolefin elastomer, suitable for a roofing membrane according to aspects of the disclosure, and comparative EPDM cross-linked materials;

FIG. 9 is a compression set plot of an example silane-crosslinked polyolefin elastomer suitable for a roofing membrane, and a comparative EPDM cross-linked material;

FIGS. 10A and 10B are schematic depictions of processing equipment for production of the roofing membrane disclosed herein;

FIG. 11A is a temperature v. % retraction plot of Examples 4, 6, Comparative Example A, and a comparative EPDM sample;

FIG. 11B is a thermal reaction v. temperature plot of Examples 4, 6, Comparative Example A, and a comparative EPDM sample;

FIG. 12A is a temperature v. relative modulus plot by Gehman testing of Examples 4, 6, Comparative Example A, and a comparative EPDM sample;

FIG. 12B is a relative modulus change v. temperature plot by Gehman testing of Examples 4, 6, Comparative Example A, and a comparative EPDM sample;

FIG. 13 shows hysteresis curves of Example 4, Comparative Example A, and a comparative EPDM sample;

FIG. 14 shows aging by stress relaxation curves by DMA of Examples 4, 6, Comparative Example A, and a comparative EPDM sample;

FIG. 15 is a temperature v. tensile stress plot of Examples 4, 6, Comparative Example A, and a comparative EPDM sample; and

FIG. 16 is a temperature v. heat flow plot of Examples 4, 6, Comparative Example A, and a comparative EPDM sample.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: percent, “parts of,” and ratio values are by weight; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within ±5% of the value. As one example, the phrase “about 100” denotes a range of 100±5, i.e. the range from 95 to 105. Generally, when the term “about” is used, it can be expected that similar results or effects according to the disclosure can be obtained within a range of ±5% of the indicated value. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . , 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. Any two numbers, of a set of numbers, may form an integer range. For example, if the disclosed numbers are 1, 2, 3, 4, 5, the range the numbers cover may be 1 to 5, 1 to 3, 2 to 4, 3 to 4, among other options.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

As used herein, the term “and/or” means that either all or only one of the elements of said group may be present. For example, “A and/or B” means “only A, or only B, or both A and B”. In the case of “only A”, the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description and does not necessarily preclude chemical interactions among constituents of the mixture once mixed. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

For purposes of this disclosure, the term “coupled” (in all of its forms, couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature or may be removable or releasable in nature unless otherwise stated.

Thermoplastic roofing membranes may be single-ply including a single layer. Alternatively, thermoplastic roofing membranes may be laminated, composed of multiple layers and may contain a reinforcing fabric or scrim reinforcement material in the center between any two of the layers of the roofing membrane. Each of the respective layers in the roofing membrane needs to demonstrate a variety of different material properties to be suited for use on a roof where the material will be exposed to sunlight and the weather elements such as fluctuating temperatures, wind, humidity, and precipitation. The material properties of the polymer layers should exhibit good adhesion, UV resistance, weatherability (durability), flame retardance, flexibility, chemical resistance, and longevity.

Various polymer systems have been developed as roofing membranes. The most commonly used polymer systems include thermoplastic polyolefin (TPO), ethylene propylene diene monomer (EPDM), and polyvinyl chloride (PVC). Depending on the material(s) selected, different advantages and disadvantages are typically observed. TPO membranes are available, affordable, and are typically white, but are susceptible to deterioration when exposed to high heat (greater than about 150° C.) and/or solar ultra-violet (UV) radiation. EPDM membranes are made from the readily available EPDM synthetic rubber, but roughly 95% of all EPDM roofing membranes produced are black, which does not meet the energy efficiency expectations of customers and/or regulations. Lastly, PVC membranes are widely available and offer good puncture, heat-weldability, and colorability. But the PVC membranes cannot stand high temperature conditions of greater than about 150° C. and are expensive to manufacture. The PVC membranes also suffer from variability in properties as produced by different manufacturers.

Roofing membranes have to meet industrial standards. For example, a TPO roofing membrane needs to exhibit at least the following mechanical properties as outlined by the ASTM 6878 specification for TPO roofing membranes: 1) a tensile strength (CD and MD) greater than 10 MPa; 2) an elongation at break (CD and MD) greater than 500%; 3) an elastic modulus (CD and MD) of less than 100 MPa; and 4) a flame retardance rating of classification D as measured in accordance with the EN ISO 11925-2 surface exposure test.

Mindful of the industrial requirements as well as advantages and drawbacks for the various TPO, EPDM, and PVC materials used to make roofing membranes, there is a need for new polymer-based roofing membrane compositions and methods of making the same which will meet or exceed the industrial standards and properties of the TPO, EPDM, and PVC and at the same time which are simpler to make. For example, it would be desirable to develop a roofing membrane composition with less production variability, lighter in weight and/or color, having superior durability over a long period of time of about 30 years of exposure to various environmental elements, or a combination thereof. Additionally, it would be useful to develop a roofing membrane capable of having a long application time of about 30 years or longer.

A novel roofing membrane is disclosed herein. The roofing membrane has numerous advantages when compared to the typical roofing membranes such as the EPDM, the TPO, and/or the PVC roofing membranes. The advantages of the herein-disclosed roofing membranes are discussed below, without limiting the disclosure to a single theory, in connection with certain properties.

For example, the roofing membrane is crosslinkable, which enables the membrane to withstand high temperatures greater than about 150° C. The crosslinking is at ambient temperatures with atmospheric moisture such that the cure proceeds over a time period instead of being instantaneous. Thus, there is no need for autoclaving or hot air curing, which is required for the EPDM material. Yet, at the same time, the herein-disclosed roofing membrane is storage stable for a relatively long time period of at least one year prior to cure. The membrane also features better flame retardance than the typical TPO membrane due to the crosslinked structure.

The herein-disclosed roofing membrane has an excellent retention of low-temperature flexibility or elasticity due to low crystallinity quantified further below and other factors such the composition and a lack of plasticizer. At least partially due to the low crystallinity, the roofing membrane has superior heat aging properties when compared to the EPDM and TPO. The membrane retains its elastic property for at least about 30 years in ambient aging conditions. The membrane also features UV stability with very little change in color and no or minimal appearance of any formation cracks, at least partially due to the retained elasticity.

The herein-disclosed membrane may be plasticizer-free. Inclusion of a plasticizer in a roofing membrane typically results in its volatilization, increased stiffness, and loss of elasticity, which is undesirable in thermoplastic roofing membranes. For example, while the typical EPDM hardness increases in time, its elongation decreases as the material becomes stiffer. Loss of elasticity may negatively influence the EPDM's ability to resist weathering conditions, heat, moisture, etc. A lack of or intentional omission of a plasticizer in the herein-disclosed roofing membrane and the composition the membrane is prepared from contributes to no or only minimal change in the hardness, elasticity, and stiffness of the herein-disclosed roofing membrane in time. The crosslinking results in a stable roofing membrane, where no additional networks, comparable to those formed in plasticizer-including EPDM membranes, are being created over time.

Additionally, the roofing membrane composition features higher melt strength than the EPDM and the TPO, which enables faster processability of the composition than the EPDM and the TPO. The roofing membrane's melt strength also enables production without a scrim layer.

The roofing membrane may be a single-ply roofing membrane or a laminated roofing membrane having at least two membrane layers. The number of membrane layers may be 2, 3, 4, 5, 6, 7, 8, 9, or more. A scrim layer may be laminated between the at least two membrane layers for various reasons such as reinforcement.

The laminated roofing membrane may have at least a top or cap layer and a bottom or core layer. The top and bottom layers may be the same or different. For example, the top and the bottom layers may differ in their dimensions, chemical composition, and/or at least one physical, mechanical, and/or rheological property. In a non-limiting example, the top layer may include a higher amount of UV and/or heat stabilizers. The bottom layer may include less or no UV stabilizers. The bottom layer may be UV stabilizer-free. The bottom layer may include heat stabilizer(s) to ensure heat stability of the membrane. The top layer may have a different value of any one or more of the properties named and/or quantified below.

The top and the bottom layers may differ in their gel content or degree of crosslinking. For example, the top layer may have higher gel content than the bottom layer. The top layer may be highly crosslinked, that is having gel content greater than about 70% and the bottom layer may be lightly crosslinked, that is having gel content between about 50 to 70%.

In a non-limiting example, the top layer may have at least one dimension different from the bottom layer. The one dimension may be thickness. For example, the top layer may have a different thickness than the bottom layer. The thickness of the top layer t₁ may be about 5, 10, 15, 20, 25, 30, 35, 40, 45, or 49% of the thickness of the bottom layer t₂. The ratio of the thickness of the top layer to the thickness of the bottom layer may be about 1:1, 1:2, 1:3, 1:4, 1:5, 1:6, 1:7, 1:8, 1:9, 1:10, 1:15, 1:20, 1:25, 1:30, 1:35, 1:40, 1:50, or the like. In a non-limiting example, the thickness of the top layer may be half of the thickness of the bottom layer. In a non-limiting embodiment, the thickness of the top layer and the bottom layer may be substantially the same.

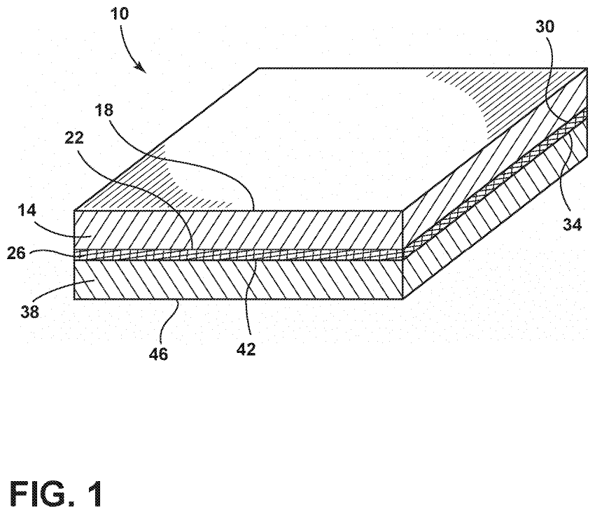

In a non-limiting example of FIG. 1, a roofing membrane 10 is disclosed. The roofing membrane 10 may include a top layer 14 having a flame retardant and a first silane-crosslinked polyolefin elastomer with a density less than 0.90 g/cm³; a scrim layer 26; and a bottom layer 38 having a flame retardant and a second silane-crosslinked polyolefin elastomer with a density less than 0.90 g/cm³. The top and bottom layers of the roofing membrane may both exhibit a compression set of from about 5.0% to about 35.0%, as measured according to ASTM D 395 (22 hrs @ 70° C.). The structure of the roofing membrane 10 is applicable to other examples of the herein-disclosed roofing membranes, the composition and properties are non-limiting examples.

Referring again to FIG. 1, a cross-sectional view of the roofing membrane 10 is provided. The roofing membrane 10 includes the top layer 14 with a first and a second surface 18, 22. The scrim layer 26 (also referred to as scrim 26) has a third and a fourth surface 30, 34, where the third surface 30 of the scrim 26 is coupled to the second surface 22 of the top layer 14. The roofing membrane 10 additionally includes a bottom layer 38 with a fifth and a sixth surface 42, 46, where the fifth surface 42 of the bottom layer 38 is coupled to the fourth surface 34 of the scrim 26.

The roofing membrane disclosed herein may include one or more scrim layers 26. The number of scrim layers may be 1, 2, 3, 4, 5, 6, 7, 8, 9, or more. Each scrim layer may include a different composition or material. The scrim layer 26 disposed between the top and bottom layers 14, 38 may serve as a reinforcement in the roofing membrane, thus adding to its structural integrity. Materials that may be used for the scrim layer(s) 26 may include, for example, woven and/or non-woven fabrics, fiberglass, and/or polyester. In one or more embodiments, additional materials that may be used for the scrim layers 26 may include synthetic materials such as polyaramids, KEVLAR™, TWARON™, polyamides, polyesters, RAYON™, NOMEX™, TECHNORA™, or a combination thereof. In some aspects, the scrim layer 26 may include aramids, polyamides, and/or polyesters.

In one or more embodiments, a tenacity of the scrim layer 26 may range from about, at least about, or at most about 100 to about 3000 denier. In other aspects, the scrim layers 26 may have a tenacity ranging from about 500 to about 1500 denier. In still other aspects, scrim layers 26 may have a tenacity of about 1000 denier. In some aspects, scrim layers 26 may have a tensile strength of greater than about, at least about, or at most about 14 kN/m (80 pounds force per inch). In other aspects, the scrim layers 26 may have a tensile strength of greater than about 10 kN/m, greater than about 15 kN/m, greater than about 20 kN/m, or greater than about 25 kN/m. Depending on the desired properties of the final roofing membrane 10, the scrim layers 26 may be varied as needed to suit particular roofing membrane designs. One of ordinary skill in the art would appreciate that such characteristics can be varied without departing from the present disclosure.

The roofing membranes 10 disclosed herein may have a variety of different dimensions. In some aspects, the roofing membrane 10 may have a length from about 30 feet to about 200 feet and a width from about 4 feet to about 12 feet. In some aspects, the roofing membrane 10 may have a width of about 10 feet. Variations in the width may provide for various advantages. For example, in some aspects, the roofing membrane 10 having smaller widths may advantageously allow for greater ease in assembly of a roofing structure. Smaller widths may also advantageously allow for greater ease in rolling or packaging of a manufactured membrane. Larger widths may advantageously allow for greater structure integrity, fast installation and/or improve the stability of a roofing structure having these membranes.

The roofing membrane disclosed herein is prepared from a roofing membrane composition, “composition,” or “reactive composition.” The composition includes one or more components. The composition comprises, consists essentially of, or consists of:

(A) Polyolefin elastomer/plastomer component;

(B) Grafting initiator(s);

(C) Silane crosslinker(s);

(D) Condensation catalyst(s);

(E) Functional filler(s);

(F) UV/heat stabilizer(s);

(G) Antioxidant(s);

(H) Fire retardant(s);

and optionally:

(I) Dispersant(s);

(J) Process or secondary stabilizer(s);

(K) Slip agent(s); and

(L) Other additive(s).

The composition is processed according to one or more methods described herein. During and after the processing, storage time, application, or a combination thereof, one or more of the components such as at least one of the components (B), (C), (D), (G), (H), (I), and (J) may be partially or fully consumed/used. It is possible that the final product, the roofing membrane, may include none or only a limited amount of at least one of the components (B), (C), (D), (G), (H), (I), and (J), the amount being substantially smaller than the amount of the same component in the roofing membrane composition.

The final product, the roofing membrane, also referred to as the silane-grafted/crosslinked polyolefin elastomeric membrane, may comprise, consist essentially of, or consists of:

(A) Polyolefin elastomer/plastomer component, silane grafted/crosslinked;

(E) Functional filler(s);

(F) UV/heat stabilizer(s);

(G) Antioxidant(s);

(H) Fire retardant(s);

and optionally:

(J) Process or secondary stabilizer(s); and

(L) Other additives.

The composition and/or the roofing membrane include (A) Polyolefin elastomer/plastomer component. The component (A) includes the base polymer(s). The component (A) may include a mixture or blend of base polymers. The component (A) may include one or more polyolefin elastomer(s) and/or plastomers. The mixture may include 2, 3, 4, 5, 6, 7, 8, 9, or more polyolefin elastomers/plastomers. The component (A) may include a polyolefin elastomer/plastomer including an olefin block copolymer, an ethylene/α-olefin copolymer, a propylene/α-olefin copolymer, EPDM, EPM, or a mixture of two or more of any of these materials. Non-limiting example block copolymers include those sold under the trade names INFUSE™, an olefin block co-polymer (the Dow Chemical Company) and SEPTON™ V-SERIES, a styrene-ethylene-butylene-styrene block copolymer (Kuraray Co., LTD.). Non-limiting example ethylene/α-olefin copolymers include those sold under the trade names TAFME™ (e.g., TAFMER DF710) (Mitsui Chemicals, Inc.), and ENGAGE™ (e.g., ENGAGE 8150) (the Dow Chemical Company). Non-limiting example propylene/α-olefin copolymers include those sold under the trade name VISTAMAXX™ 6102 grades (Exxon Mobil Chemical Company), TAFMER™ XM (Mitsui Chemical Company), and VERSIFY™ (Dow Chemical Company). Non-limiting example EPDM may have a diene content of from about 0.5 to about 10 wt. %. The EPM may have an ethylene content of about, at least about, or at most about 45 wt. % to 75 wt. %.

The term “comonomer” refers to olefin comonomers which are suitable for being polymerized with olefin monomers, such as ethylene or propylene monomers. Comonomers may include but are not limited to aliphatic C₂-C₂₀ α-olefins. Examples of suitable aliphatic C₂-C₂₀ α-olefins include ethylene, propylene, 1-butene, 4-methyl-1-pentene, 1-hexene, 1-octene, 1-decene, 1-dodecene, 1-tetradecene, 1-hexadecene, 1-octadecene and 1-eicosene. In an embodiment, the comonomer is vinyl acetate. The term “copolymer” refers to a polymer, which is made by linking more than one type of monomer in the same polymer chain. The term “homopolymer” refers to a polymer which is made by linking olefin monomers, in the absence of comonomers. The amount of comonomer may, in some embodiments, be from greater than 0 wt. % to about 12 wt. %, based on the weight of the polyolefin, including from greater than 0 wt. % to about 9 wt. %, and from greater than 0 wt. % to about 7 wt. %. In some embodiments, the comonomer content is greater than about 2 mol % of the final polymer, including greater than about 3 mol % and greater than about 6 mol %. The comonomer content may be less than or equal to about 30 mol %. A copolymer may be a random or block (heterophasic) copolymer. In some embodiments, the polyolefin is a random copolymer of propylene and ethylene.

In some aspects, the polyolefin elastomer/plastomer component (A) may include an olefin homopolymer, a blend of homopolymers, a copolymer made using two or more olefins, a blend of copolymers each made using two or more olefins, and a combination of olefin homopolymers blended with copolymers made using two or more olefins, or a combination thereof. The component (A) may include one or more olefins selected from ethylene, propylene, 1-butene, 1-propene, 1-hexene, 1-octene, and other higher 1-olefin. The component (A) may include ethylene, propylene, or both. The ethylene, propylene, or both may be present as a homopolymer, copolymer, or both.

The component (A) may include polyethylene which may be classified into several types including, but not limited to, LDPE (Low Density Polyethylene), LLDPE (Linear Low Density Polyethylene), HDPE (High Density Polyethylene), Ultra High Molecular Weight (UHMW), High Molecular Weight (HMW), Medium Molecular Weight (MMW), and Low Molecular Weight (LMW). In still other aspects, the polyethylene may be an ultra-low density ethylene elastomer. In some aspects, the component (A) may include a LDPE/silane copolymer or blend. In another embodiment, the composition is free of an ethylene-silane copolymer.

The component (A) may include a polypropylene homopolymer, a polypropylene copolymer, a polyethylene-co-propylene copolymer, or a mixture thereof. Suitable polypropylenes include but are not limited to polypropylene obtained by homopolymerization of propylene or copolymerization of propylene and an α-olefin comonomer. The component (A) may include a mixture or blend of polyolefins. The component (A) mixture may include a first polyolefin, a second polyolefin, a third polyolefin, a fourth polyolefin, a fifth polyolefin, etc.

The mixture may include, for example, one or more ethylene-based copolymers such as the first polyolefin ethylene-1-butene copolymer, the second polyolefin ethylene propylene copolymer, the third polyolefin ethylene-octene copolymer, or their combination. The individual copolymers may differ by one or more properties such as melt index or melt mass-flow rate (MFR), density, crystallinity, Shore A, Mooney viscosity, the like, or a combination thereof. The mixture of various copolymers provides a combination of various properties. The mixture thus contributes to the desirable properties of the final product once the composition is processed into the roofing membrane. The choice of specific polyolefins, their properties, weight of individual polyolefins, and a weight ratio of the polyolefins, or their combination may directly influence the final properties of the roofing membrane.

The weight of individual polyolefins in component (A) may be the same or different. At least two polyolefins in a blend of the component (A) may have the same or different weight than each other or than at least one more polyolefin of the component (A). The weight ratio may be a ratio of the first polyolefin:second polyolefin, first polyolefin:second polyolefin:third polyolefin, first polyolefin:third polyolefin, second polyolefin:third polyolefin, first polyolefin:second polyolefin:third polyolefin:fourth polyolefin, first polyolefin:second polyolefin:fourth polyolefin, first polyolefin:fourth polyolefin, second polyolefin:fourth polyolefin, etc. The ratio relates to the weight or amount of the individual polyolefins included in the component (A).

The weight ratio may be a ratio of the first polyolefin:second polyolefin in the component (A). The ratio of the first polyolefin:second polyolefin in the component (A) may be about, at least about, or at most about 19:1 to 2:1; the ratio may be about, at least about, or at most about 19:1, 18:1, 17:1, 16:1, 15:1, 14:1, 13:1, 12:1, 11:1, 10:1, 9:1, 8:1, 7:1, 6:1, 5:1, 4:1, 3:1, or 2:1. The ratio of the second polyolefin:third polyolefin in the component (A) may be about, at least about, or at most about 1:2, 1:2.5, 1:3, 1:3.5, or 1:4. A non-limiting example ratio of the first polyolefin:second polyolefin:third polyolefin in the component (A) may be about, at least about, or at most about 5.4:1:2, 16.2:1:2, or 19:1:2.

The first polyolefin may be, for example, a polyolefin having a lower MFR than a second polyolefin, but higher than a third polyolefin. The first polyolefin may have lower Shore A hardness than the second polyolefin and the third polyolefin, which may have the highest Shore A hardness from the first to third polyolefins.

In a non-limiting example, the component (A) may include a mixture of ethylene-1-butene copolymer, ethylene propylene copolymer, and two different ethylene-octene copolymers having different MFR, density, Shore A, and/or total crystallinity. In another non-limiting example, the component (A) includes a mixture of copolymers including an ethylene propylene copolymer and two different ethylene-octene copolymers having different MFR, density, Shore A, and/or total crystallinity.

In another non-limiting example, a laminated membrane has a top layer and a bottom layer, each made from different roofing membrane compositions. The composition of the top layer may include the component (A) including a mixture of copolymers. The mixture includes an ethylene-1-butene copolymer, an ethylene propylene copolymer, and two different ethylene octene copolymers. The composition of the bottom layer may include the component (A) including a mixture of copolymers. The mixture includes two different ethylene-1-butene copolymers, an ethylene propylene copolymer, and an ethylene octene copolymer. The bottom and the top layer may include at least one or two common polyolefins or copolymers having the same properties.

The one or more polyolefins of the component (A) may be synthesized using a variety of processes and optionally using a catalyst suitable for polymerizing ethylene and/or α-olefins. A metallocene catalyst may be used to produce low density ethylene/α-olefin polymers. The one or more polyolefins may be produced using a catalyst known in the art including, but not limited to, chromium catalysts, Ziegler-Natta catalysts, metallocene catalysts or post-metallocene catalysts. The process may include using gas phase and solution-based metallocene catalysis and Ziegler-Natta catalysis.

Overall, the amount of the component (A) in the composition and/or the roofing membrane may be about, at least about, or at most about 40 to 75, 45 to 72, or 50 to 68 wt. %, based on the total weight of the composition. The amount of the component (A) in the composition may be about, at least about, or at most about 40, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, 70, 70.5, 71.5, 72, 72.5, 73, 73.5, 74, 74.5, or 75 wt. %, based on the total weight of the composition.

The individual copolymers may be present in an amount of about, at least about, or at most about 1.5 to 38.5, 6.5 to 35, or 12.5 to 25 wt. %, based on the weight of the component (A). The individual copolymers may be present in an amount of about, at least about, or at most about 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, or 38.5 wt. %, based on the weight of the component (A).

The one or more polyolefins may have a molecular weight distribution M_{w}/Mₙ of less than or equal to about 5, less than or equal to about 4, from about 1 to about 3.5, or from about 1 to about 3.

The one or more polyolefins may have a melt viscosity in the range of from about, at least about, or at most about 2,000 cP to about 50,000 cP as measured using a Brookfield viscometer at a temperature of about 177° C. In some embodiments, the melt viscosity is from about 4,000 cP to about 40,000 cP, including from about 5,000 cP to about 30,000 cP and from about 6,000 cP to about 18,000 cP. The melt viscosity may be about 2000, 2500, 3000, 3500, 4000, 4500, 5000, 5500, 6000, 6500, 7000, 7500, 8000, 8500, 9000, 9500, 10,000, 11,000, 12,000, 13,000, 14,000, 15,000, 16,000, 17,000, 18,000, 19,000, 20,000, 21,000, 22,000, 23,000, 24,000, 25,000, 26,000, 27,000, 28,000, 29,000, 30,000, 31,000, 32,000, 33,000, 34,000, 35,000, 36,000, 37,000, 38,000, 39,000, 40,000, 41,000, 42,000, 43,000, 44,000, 45,000, 46,000, 47,000, 48,000, 49,000, or 50,000 cP.

The one or more polyolefins may have a melt index (T2) or melt mass-flow rate (MFR), measured at 190° C. under a 2.16 kg load, of from about, at least about, or at most about 0.5 to 100, 3.0 to 50, or 5 to 30 g/10 min. The one or more polyolefins may have MFR about, at least about, or at most about 0.5, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 31, 32, 33, 34, 35, 40, 45, 50, 55, 60, 65, 70, 75, 80, 85, 90, 95, or 100 g/10 min.

The mixture of the component (A) may include each polyolefin having different MFR. The mixture may include a number of polyolefins, each of the polyolefins having different properties including different MFR. In a non-limiting example, a first polyolefin has MFR of about 1.2, a second polyolefin has MFR of about 3.0, and a third polyolefin has MFR of about 20.

In some aspects, the density of the one or more polyolefins may be about, at least about, or at most about 0.850 to 0.906, 0.866 to 0.885, or 0.868 to 0.880 g/cm³. The density of the one or more polyolefins may be about, at least about, or at most about 0.850, 0.82, 0.854, 0.856, 0.858, 0.860, 0.862, 0.864, 0.866, 0.868, 0.870, 0.872, 0.874, 0.876, 0.878, 0.880, 0.882, 0.884, 0.886, 0.888, 0.890, 0.892, 0.894, 0.896, 0.898, 0.900, 0.902, 0.904, or 0.906 g/cm³. The density of the one or more polyolefins may be less than about 0.90 g/cm³, less than about 0.89 g/cm³, less than about 0.88 g/cm³, less than about 0.87 g/cm³, less than about 0.86 g/cm³, less than about 0.85 g/cm³, less than about 0.84 g/cm³, less than about 0.83 g/cm³, less than about 0.82 g/cm³, less than about 0.81 g/cm³, or less than about 0.80 g/cm³.

The one or more polyolefins may have total crystallinity of about, at least about, or at most about 2 to 60, 10 to 40, or 15 to 30%. The one or more polyolefins may have total crystallinity of about, at least about, or at most about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60%. The percent crystallinity of the one or more polyolefins may be less than about 60%, less than about 50%, less than about 40%, less than about 35%, less than about 30%, less than about 25%, or less than about 20%. The percent crystallinity may be at least about 10%.

The one or more polyolefins may have Shore A hardness of about, at least about, or at most about 45 to 95, 50 to 92, or 54 to 90. The one or more polyolefins may have Shore A hardness of about, at least about, or at most about 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95.

The one or more polyolefins may have tensile strength at break of about, at least about, or at most about 1.5 to 80, 8.5 to 65, or 12 to 25 MPa. The one or more polyolefins may have tensile strength at break of about, at least about, or at most about 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 MPa.

The one or more polyolefins may have Mooney viscosity measured at 121° C. at ML 1+4 of about, at least about, or no more than about 2 to 20, 4 to 18, or 8 to 12. The one or more polyolefins may have Mooney viscosity of about, at least about, or at most about 2, 3, 4, 5, 6, 7, 8, 9, 10, 11, 12, 13, 14, 15, 16, 17, 18, 19, or 20.

The blend of the one or more polyolefins of the component (A) having a density less than 0.94 g/cm³ and crystallinity less than about 40% may be used because the subsequent silane grafting and crosslinking of these polyolefin materials together are what forms the core resin structure or matrix in the final silane-crosslinked polyolefin elastomer. Although additional polyolefins may be added to the blend of the silane-grafted, silane-crosslinkable, and/or silane-crosslinked polyolefin elastomer as fillers to improve and/or modify the Young's modulus as desired for the final product, any polyolefins added to the blend having a crystallinity equal to or greater than about 40% may not be chemically or covalently incorporated into the crosslinked structure of the final silane-crosslinked polyolefin membrane.

In some aspects, the one or more polyolefins may further include one or more TPVs and/or EPDM with or without silane graft moieties where the TPV and/or EPDM polymers are present in an amount of up to 20 wt. % of the mixture.

The composition has component (B) grafting initiator(s). A grafting initiator (also referred to as a “radical initiator”) may be utilized in the grafting process of the one or more polyolefins by reacting with the respective polyolefins to form a reactive species that may react and/or couple with the silane crosslinker molecule.

The grafting initiator may include halogen molecules, azo compounds (e.g., azobisisobutyl), carboxylic peroxyacids, peroxyesters, peroxyketals, and peroxides (e.g., alkyl hydroperoxides, dialkyl peroxides, and diacyl peroxides). In some embodiments, the grafting initiator may be an organic peroxide selected from di-t-butyl peroxide, t-butyl cumyl peroxide, dicumyl peroxide, 2,5-dimethyl-2,5-di(t-butyl-peroxy)hexyne-3, 1,3-bis(t-butyl-peroxy-isopropyl)benzene, n-butyl-4,4-bis(t-butyl-peroxy)valerate, benzoyl peroxide, t-butylperoxybenzoate, t-butylperoxy isopropyl carbonate, and t-butylperbenzoate, as well as bis(2-methylbenzoyl)peroxide, bis(4-methylbenzoyl)peroxide, t-butyl peroctoate, cumene hydroperoxide, methyl ethyl ketone peroxide, lauryl peroxide, tert-butyl peracetate, di-t-amyl peroxide, t-amyl peroxybenzoate, 1,1-bis(t-butylperoxy)-3,3,5-trimethylcyclohexane, α,α′-bis(t-butylperoxy)-1,3-diisopropylbenzene, α,α′-bis(t-butylpexoxy)-1,4-diisopropylbenzene, 2,5-bis(t-butylperoxy)-2,5-dimethylhexane, and 2,5-bis(t-butylperoxy)-2,5-dimethyl-3-hexyne and 2,4-dichlorobenzoyl peroxide. Non-limiting example peroxides may include those sold under the tradename LUPEROX™ (available from Arkema, Inc.). The component (B) may include a silane mixture. The silane mixture may be a silane-peroxide mixture. The silane mixture may include trimethoxy vinyl silane, triethyloxy vinyl silane, and a peroxide mixture to supply silane crosslinking.

The grafting initiator may be present in an amount of from greater than about 0 wt. % to about 2 wt. %, based on the total weight of the composition. The grafting initiator may be present in an amount of about, at least, or at most about 0 to 4, 0.15 to 2, or 0.5 to 1.5 wt. %, based on the total weight of the composition. The grafting initiator may be present in an amount of about, at least, or at most about 0, 0.2, 0.4, 0.6, 0.8, 1.0, 1.2, 1.4, 1.6, 1.8, 2.0, 2.2, 2.4, 2.6, 2.8, 3.0, 3.2, 3.4, 3.6, 3.8, or 4.0 wt. %, based on the total weight of the composition. Each amount of the grafting initiator corresponds to a different degree of grafting/gel content in the membrane.

The amount of the grafting initiator (B) and the silane crosslinker(s) (C) employed may affect the final structure of the silane grafted polymer (e.g., the degree of grafting in the grafted polymer and the degree of crosslinking in the cured polymer). A fully grafted/crosslinked membrane exhibits high gel content of more than about 70%.

The degree of grafting and/or crosslinking may be utilized when designing the laminated membrane. For example, in a laminated membrane, the amount of (B) and/or (C) in the top layer may be higher than in the bottom layer. As a result, the top layer may be highly cross-linked having gel content of about 70% or greater. The bottom layer may be lightly cross-linked having gel content of about 50 to 70% or lower.

Additionally, since the amount of (B) and/or (C) influences the degree of grafting and crosslinking, controlled grafting may be implemented to provide a roofing membrane with a long period of storage capacity exceeding several weeks or months. The roofing membrane may be designed to be only partially cross-linked after the membrane is produced with a relatively low amount of gel content of about 50 to 70%. Such arrangement enables that the membrane may be welded after a prolonged storage exceeding several weeks or months.

In some aspects, the reactive composition contains at least 100 ppm of initiator, or at least 300 ppm of initiator. The initiator may be present in an amount from about 300 ppm to about 1500 ppm or from about 300 ppm to about 2000 ppm. The initiator may be present in an amount of about, at least about, or at most about 100 to 2000, 300 to 1800, or 500 to 1500 ppm. The initiator may be present in an amount of about, at least about, or at most about 100, 200, 300, 400, 500, 600, 700, 800, 900, 1000, 1100, 1200, 1300, 1400, 1500, 1600, 1700, 1800, 1900, or 2000 ppm. The silane:initiator weight ratio may be from about 20:1 to 400:1, including from about 30:1 to about 400:1, from about 48:1 to about 350:1, and from about 55:1 to about 333:1. The silane:initiator weight ratio may about, at least about, or at most about 20:1 to 400:1, 30:1 to 350:1, or 50:1 to 333:1. The silane:initiator weight ratio may about, at least about, or at most about 20:1, 30:1, 40:1, 50:1, 60:1, 70:1, 80:1, 90:1, 100:1, 110:1, 120:1, 130:1, 140:1, 150:1, 160:1, 170:1, 180:, 190:1, 200:1, 210:1, 220:1, 230:1, 240:1, 250:1, 260:1, 270:1, 280:1, 290:1, 300:1, 310:1, 320:1, 330:1, 340:1, 350:1, 360:1, 370:1, 380:1, 390:1, or 400:1.

The grafting reaction may be performed under conditions that optimize grafts onto the interpolymer backbone while minimizing side reactions (e.g., the homopolymerization of the grafting agent). The grafting reaction may be performed in a melt, in solution, in a solid-state, and/or in a swollen-state. The silanation may be performed in a wide-variety of equipment (e.g., twin screw extruders, single screw extruders, Brabenders, internal mixers such as Banbury mixers, and batch reactors).

In some embodiments, the one or more polyolefins (A), the grafting initiator(s) (B), and the silane crosslinker(s) (C) are mixed in the first stage of an extruder. Example melt temperature (i.e., the temperature at which the polymer starts melting and begins to flow) may be from about 120° C. to about 260° C., including from about 130° C. to about 250° C.

The composition includes the component (C) Silane crosslinker(s). A silane crosslinker may be used to covalently graft silane moieties onto one or more polyolefins such as the first and second polyolefins. The silane crosslinker may include alkoxysilanes, siloxanes, or a combination thereof. The grafting and/or coupling of the various potential silane crosslinkers or silane crosslinker molecules is facilitated by the reactive species formed by the grafting initiator reacting with the respective silane crosslinker.

In some aspects, the silane crosslinker is a siloxane where the siloxane may include, for example, polydimethylsiloxane (PDMS) and octamethylcyclotetrasiloxane.

In some aspects, the silane crosslinker is an alkoxysilane. As used herein, the term “alkoxysilane” refers to a compound that includes a silicon atom, at least one alkoxy group and at least one other organic group, wherein the silicon atom is bonded with the organic group by a covalent bond. Preferably, the alkoxysilane is selected from alkylsilanes; acryl-based silanes; vinyl-based silanes; aromatic silanes; epoxy-based silanes; amino-based silanes and amines that possess —NH₂, —NHCH₃ or —N(CH₃)₂; ureide-based silanes; mercapto-based silanes; and alkoxysilanes which have a hydroxyl group (i.e., —OH). An acryl-based silane may be selected from the group comprising beta-acryloxyethyl trimethoxysilane; beta-acryloxy propyl trimethoxysilane; gamma-acryloxyethyl trimethoxysilane; gamma-acryloxypropyl trimethoxysilane; beta-acryloxyethyl triethoxysilane; beta-acryloxypropyl triethoxysilane; gamma-acryloxyethyl triethoxysilane; gamma-acryloxypropyl triethoxysilane; beta-methacryloxyethyl trimethoxysilane; beta-methacryloxypropyl trimethoxysilane; gamma-methacryloxyethyl trimethoxysilane; gamma-methacryloxypropyl trimethoxysilane; beta-methacryloxyethyl triethoxysilane; beta-methacryloxypropyl triethoxysilane; gamma-methacryloxyethyl triethoxysilane; gamma-methacryloxypropyl triethoxysilane; 3-methacryloxypropylmethyl diethoxysilane. A vinyl-based silane may be selected from the group comprising vinyl trimethoxysilane; vinyl triethoxysilane; p-styryl trimethoxysilane, methylvinyldimethoxysilane, vinyldimethylmethoxysilane, divinyldimethoxysilane, vinyltris(2-methoxyethoxy)silane, and vinylbenzylethylenediaminopropyltrimethoxysilane. An aromatic silane may be selected from phenyltrimethoxysilane and phenyltriethoxysilane. An epoxy-based silane may be selected from the group comprising 3-glycydoxypropyl trimethoxysilane; 3-glycydoxypropylmethyl diethoxysilane; 3-glycydoxypropyl triethoxysilane; 2-(3,4-epoxycyclohexyl)ethyl trimethoxysilane, and glycidyloxypropylmethyldimethoxysilane. An amino-based silane may be selected from the group comprising 3-aminopropyl triethoxysilane; 3-aminopropyl trimethoxysilane; 3-aminopropyldimethyl ethoxysilane; 3-aminopropylmethyldiethoxysilane; 4-aminobutyltriethoxysilane; 3-aminopropyldiisopropyl ethoxysilane; 1-amino-2-(dimethylethoxysilyl)propane; (aminoethylamino)-3-isobutyldimethyl methoxysilane; N-(2-aminoethyl)-3-aminoisobutylmethyl dimethoxysilane; (aminoethylaminomethyl)phenetyl trimethoxysilane; N-(2-aminoethyl)-3-aminopropylmethyl dimethoxysilane; N-(2-aminoethyl)-3-aminopropyl trimethoxysilane; N-(2-aminoethyl)-3-aminopropyl triethoxysilane; N-(6-aminohexyl)aminomethyl trimethoxysilane; N-(6-aminohexyl)aminomethyl trimethoxysilane; N-(6-aminohexyl)aminopropyl trimethoxysilane; N-(2-aminoethyl)-1,1-aminoundecyl trimethoxysilane; 1,1-aminoundecyl triethoxysilane; 3-(m-aminophenoxy)propyl trimethoxysilane; m-aminophenyl trimethoxysilane; p-aminophenyl trimethoxysilane; (3-trimethoxysilylpropyl)diethylenetriamine; N-methylaminopropylmethyl dimethoxysilane; N-methylaminopropyl trimethoxysilane; dimethylaminomethyl ethoxysilane; (N,N-dimethylaminopropyl)trimethoxysilane; (N-acetylglycysil)-3-aminopropyl trimethoxysilane, N-phenyl-3-aminopropyltrimethoxysilane, N-phenyl-3-aminopropyltriethoxysilane, phenylaminopropyltrimethoxysilane, aminoethylaminopropyltrimethoxysilane, and aminoethylaminopropylmethyldimethoxysilane. An ureide-based silane may be 3-ureidepropyl triethoxysilane. A mercapto-based silane may be selected from the group comprising 3-mercaptopropylmethyl dimethoxysilane, 3-mercaptopropyl trimethoxysilane, and 3-mercaptopropyl triethoxysilane. An alkoxysilane having a hydroxyl group may be selected from the group comprising hydroxymethyl triethoxysilane; N-(hydroxyethyl)-N-methylaminopropyl trimethoxysilane; bis(2-hydroxyethyl)-3-aminopropyl triethoxysilane; N-(3-triethoxysilylpropyl)-4-hydroxy butylamide; 1,1-(triethoxysilyl)undecanol; triethoxysilyl undecanol; ethylene glycol acetal; and N-(3-ethoxysilylpropyl)gluconamide.

In some aspects, the alkylsilane may be expressed with a general formula: RₙSi(OR′)₄₋ₙ, wherein: n is 1, 2 or 3; R is a C₁₋₂₀ alkyl or a C₂₋₂₀ alkenyl; and R′ is an C₁₋₂₀ alkyl. The term “alkyl” by itself or as part of another substituent, refers to a straight, branched or cyclic saturated hydrocarbon group joined by single carbon-carbon bonds having 1 to 20 carbon atoms, for example 1 to 10 carbon atoms, for example 1 to 8 carbon atoms, preferably 1 to 6 carbon atoms. When a subscript is used herein following a carbon atom, the subscript refers to the number of carbon atoms that the named group may contain. Thus, for example, C₁₋₆ alkyl means an alkyl of one to six carbon atoms. Examples of alkyl groups are methyl, ethyl, propyl, isopropyl, butyl, isobutyl, sec-butyl, f-butyl, 2-methylbutyl, pentyl, iso-amyl and its isomers, hexyl and its isomers, heptyl and its isomers, octyl and its isomer, decyl and its isomer, dodecyl and its isomers. The term “C₂₋₂₀ alkenyl” by itself or as part of another substituent, refers to an unsaturated hydrocarbyl group, which may be linear, or branched, comprising one or more carbon-carbon double bonds having 2 to 20 carbon atoms. Examples of C₂₋₆ alkenyl groups are ethenyl, 2-propenyl, 2-butenyl, 3-butenyl, 2-pentenyl and its isomers, 2-hexenyl and its isomers, 2,4-pentadienyl and the like.

In some aspects, the alkylsilane may be selected from the group including methyltrimethoxysilane; methyltriethoxysilane; ethyltrimethoxysilane; ethyltriethoxysilane; propyltrimethoxysilane; propyltriethoxysilane; hexyltrimethoxysilane; hexyltriethoxysilane; octyltrimethoxysilane; octyltriethoxysilane; decyltrimethoxysilane; decyltriethoxysilane; dodecyltrimethoxysilane: dodecyltriethoxysilane; tridecyltrimethoxysilane; dodecyltriethoxysilane; hexadecyltrimethoxysilane; hexadecyltriethoxysilane; octadecyltrimethoxysilane; octadecyltriethoxysilane, trimethylmethoxysilane, methylhydrodimethoxysilane, dimethyldimethoxysilane, diisopropyldimethoxysilane, diisobutyldimethoxysilane, isobutyltrimethoxysilane, n-butyltrimethoxysilane, n-butylmethyldimethoxysilane, phenyltrimethoxysilane, phenyltrimethoxysilane, phenylmethyldimethoxysilane, triphenylsilanol, n-hexyltrimethoxysilane, n-octyltrimethoxysilane, isooctyltrimethoxysilane, decyltrimethoxysilane, hexadecyltrimethoxysilane, cyclohexylmethyldimethoxysilane, cyclohexylethyldimethoxysilane, dicyclopentyldimethoxysilane, tert-butylethyldimethoxysilane, tert-butylpropyldimethoxysilane, dicyclohexyldimethoxysilane, and a combination thereof.

In some aspects, the alkylsilane compound may be selected from triethoxyoctylsilane, trimethoxyoctylsilane, and a combination thereof.

Additional examples of silanes that can be used as silane crosslinkers include, but are not limited to, those of the general formula CH₂═CR—(COO)ₓ(CₙH₂ₙ)_{y}SiR′₃, wherein R is a hydrogen atom or methyl group; x is 0 or 1; y is 0 or 1; n is an integer from 1 to 12; each R′ can be an organic group and may be independently selected from an alkoxy group having from 1 to 12 carbon atoms (e.g., methoxy, ethoxy, butoxy), aryloxy group (e.g., phenoxy), araloxy group (e.g., benzyloxy), aliphatic acyloxy group having from 1 to 12 carbon atoms (e.g., formyloxy, acetyloxy, propanoyloxy), amino or substituted amino groups (e.g., alkylamino, arylamino), or a lower alkyl group having 1 to 6 carbon atoms. x and y may both equal 1. In some aspects, no more than one of the three R′ groups is an alkyl. In other aspects, not more than two of the three R′ groups is an alkyl.

Any silane or mixture of silanes known in the art that can effectively graft to and crosslink an olefin polymer may be used in the practice of the present disclosure. In some aspects, the silane crosslinker can include, but is not limited to, unsaturated silanes which include an ethylenically unsaturated hydrocarbyl group (e.g., a vinyl, allyl, isopropenyl, butenyl, cyclohexenyl or a gamma-(meth)acryloxy allyl group) and a hydrolyzable group (e.g., a hydrocarbyloxy, hydrocarbonyloxy, or hydrocarbylamino group). Non-limiting examples of hydrolyzable groups include, but are not limited to, methoxy, ethoxy, formyloxy, acetoxy, proprionyloxy, and alkyl, or arylamino groups. In other aspects, the silane crosslinkers are unsaturated alkoxy silanes which can be grafted onto the polymer. In still other aspects, additional exemplary silane crosslinkers include vinyltrimethoxysilane, vinyltriethoxysilane, 3-(trimethoxysilyl)propyl methacrylate gamma-(meth)acryloxypropyl trimethoxysilane), and mixtures thereof.

The silane crosslinker may be present in the composition in an amount of from greater than 0 wt. % to about 10 wt. %, including from about 0.5 wt. % to about 5 wt. %, based on the total weight of the composition. The amount of the component (C) silane crosslinker may be varied based on the nature of the olefin polymer(s), the silane itself, the processing conditions, the grafting efficiency, the application, and other factors. The amount of silane crosslinker may be about, at least about, or at most about 2 wt. %, including at least 4 wt. % or at least 5 wt. %, based on the weight of the reactive composition. In other aspects, the amount of the silane crosslinker may be at least about 10 wt. %, based on the weight of the reactive composition. In still other aspects, the silane crosslinker content may be at least 1 wt. %, based on the weight of the reactive composition. In some embodiments, the silane crosslinker fed to the extruder may include from about 0.5 wt. % to about 10 wt. % of silane monomer, from about 1 wt. % to about 5 wt. % silane monomer, or from about 2 wt. % to about 4 wt. % silane monomer. The amount of the silane crosslinker may be about, at least about, or at most about 0 to 10, 0.5 to 8, or 1.5 to 5 wt. %, based on the total weight of the composition. The amount of the silane crosslinker may be about, at least about, or at most about 0, 0.5, 1, 1.5, 2, 2.5, 3, 3.5, 4, 4.5, 5, 5.5, 6, 6.5, 7, 7.5, 8, 8.5, 9, 9.5, or 10 wt. %, based on the total weight of the composition.

The composition includes component (D) one or more condensation catalyst(s). A condensation catalyst may facilitate both the hydrolysis and subsequent condensation of the silane grafts on the silane-grafted polyolefin elastomer to form crosslinks. In some aspects, the crosslinking can be aided by the use of an electron beam radiation. In some aspects, the condensation catalyst can include, for example, organic bases, carboxylic acids, and organometallic compounds (e.g., organic titanates and complexes or carboxylates of lead, cobalt, iron, nickel, zinc, and tin). In other aspects, the condensation catalyst can include fatty acids and metal complex compounds such as metal carboxylates; aluminum triacetyl acetonate, iron triacetyl acetonate, manganese tetraacetyl acetonate, nickel tetraacetyl acetonate, chromium hexaacetyl acetonate, titanium tetraacetyl acetonate and cobalt tetraacetyl acetonate; metal alkoxides such as aluminum ethoxide, aluminum propoxide, aluminum butoxide, titanium ethoxide, titanium propoxide and titanium butoxide; metal salt compounds such as sodium acetate, tin octylate, lead octylate, cobalt octylate, zinc octylate, calcium octylate, lead naphthenate, cobalt naphthenate, dibutyltin dioctoate, dibutyltin dilaurate, dibutyltin maleate and dibutyltin di(2-ethylhexanoate); acidic compounds such as formic acid, acetic acid, propionic acid, p-toluenesulfonic acid, trichloroacetic acid, phosphoric acid, monoalkylphosphoric acid, dialkylphosphoric acid, phosphate ester of p-hydroxyethyl (meth)acrylate, monoalkylphosphorous acid and dialkylphosphorous acid; acids such as p-toluenesulfonic acid, phthalic anhydride, benzoic acid, benzenesulfonic acid, dodecylbenzenesulfonic acid, formic acid, acetic acid, itaconic acid, oxalic acid and maleic acid, ammonium salts, lower amine salts or polyvalent metal salts of these acids, sodium hydroxide, lithium chloride; organometal compounds such as diethyl zinc and tetra(n-butoxy)titanium; and amines such as dicyclohexylamine, triethylamine, N,N-dimethylbenzylamine, N,N,N′,N′-tetramethyl-1,3-butanediamine, diethanolamine, triethanolamine and cyclohexylethylamine. In still other aspects, the condensation catalyst can include ibutyltindilaurate, dioctyltin maleate, dibutyltin diacetate, dibutyltin dioctoate, dioctyltin dilaurate, stannous acetate, stannous octoate, lead naphthenate, zinc caprylate, and cobalt naphthenate. Depending on the desired final material properties of the one or more silane-crosslinked polyolefins, a single condensation catalyst or a mixture of condensation catalysts may be utilized.

The condensation catalyst(s) may be present in an amount of from about 0.0 wt. % to about 1.0 wt. %, including from about 0.25 wt. % to about 8 wt. %, based on the total weight of the composition. The composition may include about, at least about, or at most about 0 to 5, 0.01 to 2, or 0.25 to 1.25 wt. %, based on the total weight of the composition, of one or more condensation catalyst(s). In one or more embodiments, the condensation catalyst may be present in an amount of from 0.25 wt. % to 8 wt. %. In other aspects, the condensation catalyst may be included in an amount of from about 1 wt. % to about 10 wt. % or from about 2 wt. % to about 5 wt. %. The amount of the condensation catalyst may be limited to under about 1 wt. % for tin catalysts.

In one or more embodiments, a crosslinking system may include and/or use one or all of a combination of radiation, heat, moisture, and additional condensation catalyst.

The composition may include component (E) functional filler(s).

The one or more filler(s) may be extruded with the silane-grafted polyolefin and in some aspects may include additional polyolefins having a crystallinity greater than 20%, greater than 30%, greater than 40%, or greater than 50% and/or MFR of about, at least about, or at most about 15 to 30, 18 to 26, or 20 to 25 g/10 min. For example, the component (E) may include polypropylene or polyethylene having MFR (190° C., 2.16 kg): 25 g/10 min. The filler polyolefin may include polypropylene, poly(ethylene-co-propylene), and/or other ethylene/α-olefin copolymers. The addition of the filler polyolefin may increase the Young's modulus by at least 10%, by at least 25%, or by at least 50% for the final silane-crosslinked polyolefin elastomer.

In some aspects, the filler(s) may include metal oxides such as titanium dioxide, metal hydroxides, metal carbonates, metal sulfates, metal silicates, clays, talcs, carbon black, calcium carbonate, and/or silicas. Depending on the application and/or desired properties, these materials may be fumed or calcined.

With further regard to the fillers, the metal of the metal oxide, metal hydroxide, metal carbonate, metal sulfate, or metal silicate may be selected from alkali metals (e.g., lithium, sodium, potassium, rubidium, caesium, and francium); alkaline earth metals (e.g., beryllium, magnesium, calcium, strontium, barium, and radium); transition metals (e.g., zinc, molybdenum, cadmium, scandium, titanium, vanadium, chromium, manganese, iron, cobalt, nickel, copper, yttrium, zirconium, niobium, technetium, ruthernium, rhodium, palladium, silver, hafnium, taltalum, tungsten, rhenium, osmium, indium, platinum, gold, mercury, rutherfordium, dubnium, seaborgium, bohrium, hassium, and copernicium); post-transition metals (e.g., aluminum, gallium, indium, tin, thallium, lead, bismuth, and polonium); lanthanides (e.g., lanthanum, cerium, praseodymium, neodymium, promethium, samarium, europium, gadolinium, terbium, dysprosium, holmium, erbium, thulium, ytterbium, and lutetium); actinides (e.g., actinium, thorium, protactinium, uranium, neptunium, plutonium, americium, curium, berkelium, californium, einsteinium, fermium, mendelevium, nobelium, and lawrencium); germanium; arsenic; antimony; and astatine.

The component (E) may include titanium dioxide, a rutile white pigment, which may be added to the formulation to provide opacity and/or color. In addition, the titanium dioxide may also provide UV light protection. In one or more embodiments, the titanium dioxide may be pre-blended with the one or more polyolefins to ensure complete dispersal of the titanium dioxide throughout the composition. In one or more embodiments, to ensure complete dispersal of the titanium dioxide into the composition, prior to extrusion or other formation techniques, the titanium dioxide may be pre-blended with the one or more polyolefins.

The one or more filler(s) of the component (E) may be present, individually or in total, in the composition in an amount of from greater than about 0 wt. % to about 50 wt. %, including from about 1 wt. % to about 20 wt. %, and from about 3 wt. % to about 10 wt. %, based on the total weight of the composition. The composition may include the component (E) in an amount of about, at least about, or at most about 0 to 50, 1 to 20, or 3 to 10 wt. %, based on the total weight of the composition. The composition may include the component (E) in an amount of about, at least about, or at most about 0, 0.5, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50, 1 to 20, or 3 to 10 wt. %, based on the total weight of the composition.

The composition includes component (F) UV and/or heat stabilizer(s). The component (F) may include one or more UV and/or heat stabilizer(s). The stabilizers may be used to enhance color retention, improve durability, maintain surface properties such as gloss, prevent cracking, extend lifetime of the accessory, and the like.

The stabilizer(s) may include Ultraviolet Light Absorbers (UVA), Hindered-Amine Light Stabilizers (HALS), or both. Non-limiting examples of stabilizers may include high molecular weight hydroxylamine, phosphite processing stabilizers, or phenolic stabilizers.

The composition may include about, at least about, or at most about 0 to 3.0, 0.1 to 2.5, or 0.5 to 1.5 wt. % of the component (F), based on the total weight of the composition. The composition may include about, at least about, or at most about 0, 0.1, 0.2, 0.3, 0.4, 0.5, 0.6, 0.7, 0.8, 0.9, 1.0, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 wt. % of the component (F), based on the total weight of the composition.

A laminated membrane may include a different amount and/or different composition of the component (F) in the top layer than in the bottom layer. For example, the top layer may include a higher amount of the UV and heat stabilizer(s) than the bottom layer. The bottom layer may include about, at most about, or no more than about ½, ¼, ⅛, 1/12, 1/16, 1/24, or 1/32 of the weight of the UV and heat stabilizer(s) of the top layer. The bottom layer may not include any UV stabilizer(s). The bottom layer may be UV-stabilizer free.

The composition may include one or more antioxidants of component (G). The antioxidant(s) may be added to protect the final product against oxygen. A non-limiting example of an antioxidant may be a hindered phenolic antioxidant, amine-based antioxidant, phosphite-based antioxidant, or a propionate-based antioxidant. Non-limiting examples of antioxidants may include Pentaerythritol tetrakis[3-[3,5-di-tert-butyl-4-hydroxyphenyl]propionate, Octadecyl-3-[3,5-di-tert-butyl-4-hydroxyphenyl]propionate], 2′,3-bis[[3-[3,5-di-tert-butyl-4-hydroxyphenyl]propionyl]]proponiohydrazine, a blend of bis(hydrogenated tallow alkyl) amines and tris(2,4-di-tert.-butylphenyl)phosphite, Tris(2,4-ditert-butylphenyl)phosphite, or a combination thereof.

The composition may include about, at least about, or at most about 0 to 2.0, 0.1 to 1.5, or 0.5 to 1.0 wt. % of the component (G). The composition may include about, at least about, or at most about 0.0, 0.1, 0.2, 0.3, 0.4, 0.5, 0.6, 0.7, 0.8, 0.9, 1.0, 1.2, 1.3, 1.4, 1.5, 1.6, 1.7, 1.8, 1.9, or 2.0 wt. % of the component (G).

The composition includes one or more fire retardant(s) of component (H). The fire retardant(s) may be halogen-free. Non-limiting example fire retardants include magnesium hydroxide. The magnesium hydroxide may be a high purity grade of magnesium hydroxide.

The one or more flame retardants may be used in combination with the one or more polyolefins employed in the top and/or the bottom layers 14, 38 of the roofing membrane. For example, magnesium hydroxide may provide flame retardant properties in the top and/or bottom layers. Magnesium hydroxide may be extruded or blended with the silane-grafted polyolefin elastomer to ensure complete dispersal in the composition blend.

The fire retardant(s) such as magnesium hydroxide may be blended with the silane-grafted polyolefin elastomer in an amount up to about 70 wt. % magnesium hydroxide, based on the total weight of the composition. In another non-limiting example, the magnesium hydroxide in the silane-grafted polyolefin elastomer may make up between about 20 wt. % and 75 wt. %, based on the total weight of the roofing membrane composition.

The composition may include about, at least about, or at most about 9 to 45, 15 to 40, or 20 to 35 wt. %, based on the total weight of the composition, of the component (H). The composition may include about, at least about, or at most about 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, or 45 wt. %, based on the total weight of the composition, of the component (H).

The composition may further include one or more optional components such as component (I) one or more dispersants. The one or more dispersants may serve as a carrier material for highly polar materials within the composition. The component (I) may contribute to easier dispersion of materials into the matrix. A non-limiting example of the component (I) may be butyl acrylate including a random copolymer of a polyolefin such as ethylene and butyl acrylate. The random copolymer may have butyl acrylate content of about 5 to 20 or 16 to 18 wt. %, based on the total weight of the random copolymer. The random copolymer may have melt index (MI) of about 6.5 to 8 g/10 min; density (23° C.) of about 0.93 g/cm³, or a combination thereof.

The amount of the component (I) in the composition may be about, at least about, or at most about 0 to 5, 1 to 4.6, or 3 to 4 wt. %, based on the total weight of the composition. The amount of the component (I) in the composition may be about, at least about, or at most about 0, 0.5, 1, 1.5, 2, 2.5, 3, 3.5, 4, 4.5, or 5 wt. %, based on the total weight of the composition.

The composition may further include one or more process or secondary stabilizer(s) of component (J). The one or more process stabilizer(s) may include acid scavengers, polyolefin-specific stabilizers, process improvers, anti-blocking agents, lubricants, viscosity controllers, smoke inhibitors, etc. Non-limiting examples of the component (J) may be a silicone-based additive.

The component (J) may include one or more waxes e.g., paraffin waxes, microcrystalline waxes, HDPE waxes, LDPE waxes, thermally degraded waxes, byproduct polyethylene waxes, optionally oxidized Fischer-Tropsch waxes, and functionalized waxes. An example wax may include an organic modified siloxane-based wax.

The component (J) may be included in an amount of about, at least about, or at most about 0 to 5, 0.02 to 2, or 0.8 to 1.5 wt. %, based on the total weight of the composition. The component (J) may be included in an amount of about, at least about, or at most about 0.02, 0.05, 0.1, 0.2, 0.3, 0.4, 0.5, 0.6, 0.7, 0.8, 0.9, 1.0, 1.5, 2.0, 2.5, 3.0, 3.5, 4.0, 4.5, or 5 wt. %, based on the total weight of the composition.

The composition may include one or more slip or anti-block agent(s) of component (K). The one or more slip agent(s) (K) may be added to the composition to reduce the surface friction created during processing at the polymer surface. The slip agent(s) may have low volatility and/or good oxidative stability. Non-limiting examples of the one or more slip agent(s) may include an erucamide of vegetable origin, a primary amide.

The composition may include about, at least about, or at most about 0 to 5, 0.02 to 2, or 0.8 to 1.5 wt. % of the component (K), based on the total weight of the composition. The component (K) may be included in an amount of about, at least about, or at most about 0.02, 0.05, 0.1, 0.2, 0.3, 0.4, 0.5, 0.6, 0.7, 0.8, 0.9, 1.0, 1.5, 2.0, 2.5, 3.0, 3.5, 4.0, 4.5, or 5 wt. %, based on the total weight of the composition.

The composition may include one or more additives (L). The component (L) may include one or more antistatic agents, dyes, pigments, nucleating agents, texturizers, smoke inhibitors, biocides, fungicides, insecticides, algaecides, the like, or a combination thereof. The component (L) may include one or more oils. Non-limiting types of oils include white mineral oils and/or naphthenic oils. In some embodiments, the oil(s) are present in an amount of from about 0 to 10, 2 to 8, or 3 to 5 wt. %, based on the total weight of the composition. The component (L) may include zinc oxide, carbon black, talc, or a combination thereof. Non-limiting example pigments may include one or more types of clay, silica, or talc. Additional inorganic pigment examples may include pigments based on Al, Ba, Cu, Mn, Co, Fe, Cd, Cr, Sb, Zn, Ti, the like, or their combination. The pigments may be organic.

The component (L) may include one or more tackifying resins (e.g., aliphatic hydrocarbons, aromatic hydrocarbons, modified hydrocarbons, terpens, modified terpenes, hydrogenated terpenes, rosins, rosin derivatives, hydrogenated rosins, and mixtures thereof). The tackifying resins may have a ring and ball softening point in the range of from 70° C. to about 150° C. and viscosity of less than about 3,000 cP at 177° C.

The composition may include about, at least about, or at most about 0 to 10, 0.02 to 5, or 0.8 to 3 wt. % of the component (L), based on the total weight of the composition. The component (L) may be included in an amount of about, at least about, or at most about 0.02, 0.05, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, or 10 wt. %, based on the total weight of the composition.

A method of making the roofing membrane from the composition described above is disclosed herein. The synthesis/production of the silane-crosslinked polyolefin elastomer/plastomer membrane may be performed by using a two-step as Sioplas process, which the first step is to make silane grafting polyolefin elastomer in twin screw extruder/buss kneader/inter mixer, then extruded into membrane through 2^{nd} step with all other additive; or combining the respective components in one extruder by using a single-step as Monosil process, which eliminates the need for additional steps of mixing and shipping rubber compounds prior to extrusion.

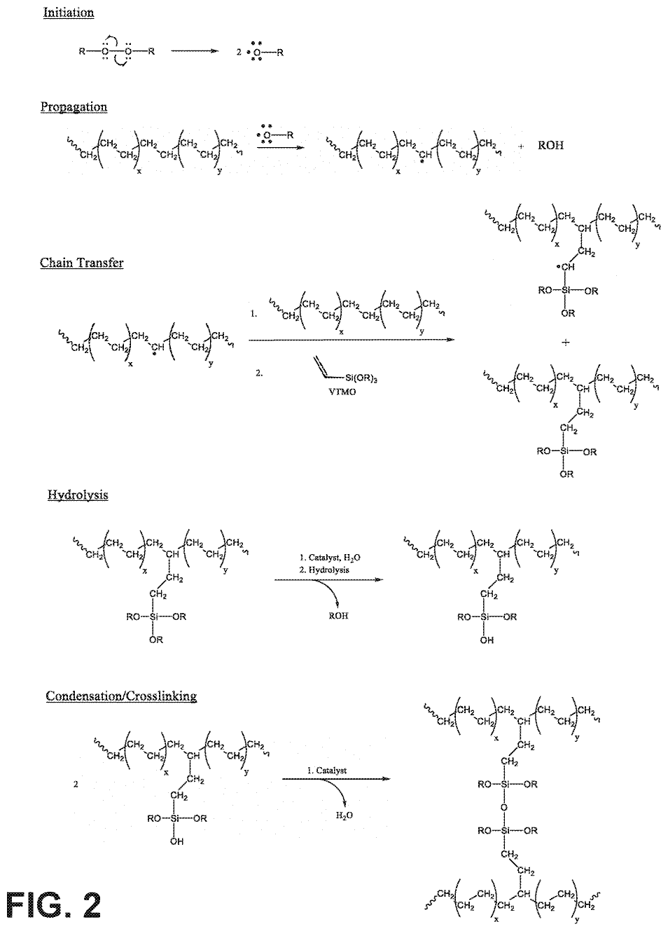

Referring now to FIG. 2, the general chemical process used during both the single-step Monosil process and two-step Sioplas process used to synthesize the silane-crosslinked polyolefin elastomer is provided. The process starts with a grafting step that includes initiation from a grafting initiator followed by propagation and chain transfer with the first and second polyolefins. The grafting initiator, in some aspects a peroxide or azo compound, homolytically cleaves to form two radical initiator fragments that transfer to one of the first and second polyolefin chains through a propagation step. The free radical, now positioned on a polyolefin chain, can then transfer to a silane molecule and/or another polyolefin chain. Once the initiator and free radicals are consumed, the silane grafting reaction for one or more polyolefins is complete.

Still referring to FIG. 2, once the silane grafting reaction is complete, a mixture of stable silane-grafted polyolefins is produced. A crosslinking catalyst may then be added to the silane-grafted polyolefins to form the silane-grafted polyolefin elastomer. The crosslinking catalyst may first facilitate the hydrolysis of the silyl group grafted onto the polyolefin backbones to form reactive silanol groups. The silanol groups may then react with other silanol groups on other polyolefin molecules to form a crosslinked network of elastomeric polyolefin polymer chains linked together through siloxane linkages. The density of silane crosslinks throughout the silane-grafted polyolefin elastomer can influence the material properties exhibited by the elastomer, as was discussed above

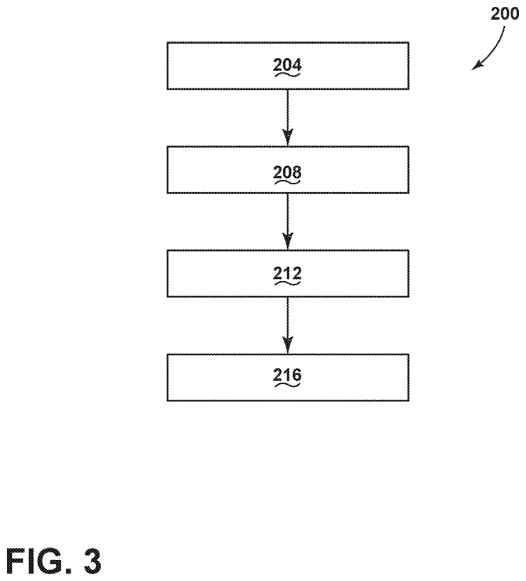

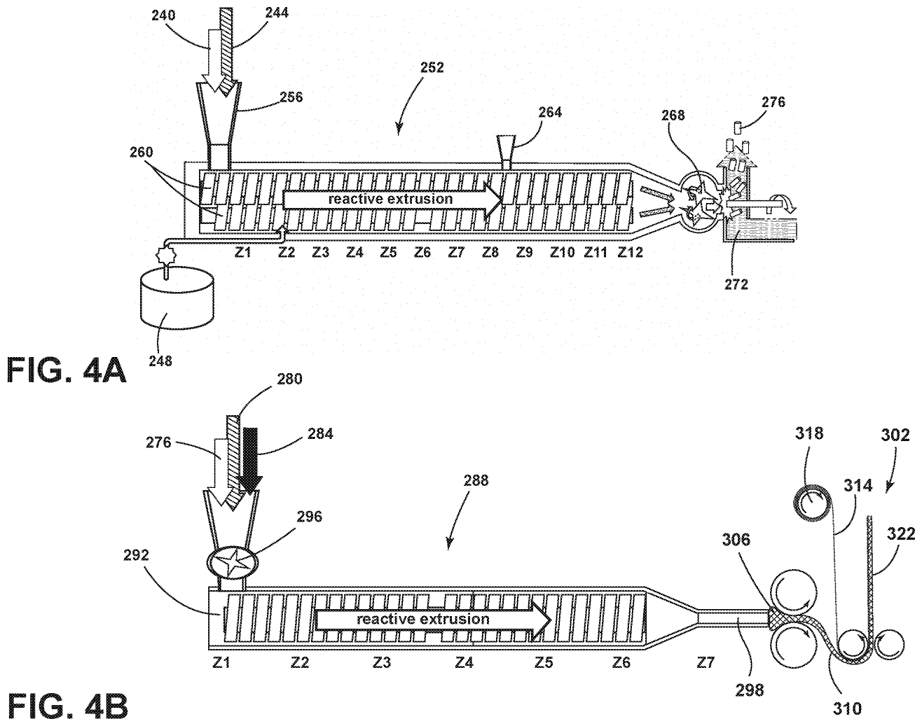

Referring now to FIGS. 3 and 4A, a method 200 for making the roofing membrane 10, using the two-step Sioplas process is shown. The method 200 may begin with a step 204 that includes extruding (e.g., with a twin screw extruder 252) a first polyolefin 240, a second polyolefin 244, and a silane cocktail 248 including the silane crosslinker (e.g., vinyltrimethoxy silane, VTMO) and the grafting initiator (e.g. dicumyl peroxide) together to form a silane-grafted polyolefin blend. The first polyolefin 240 and second polyolefin 244 may be added to a reactive twin screw extruder 252 using an addition hopper 256. The silane cocktail 248 may be added to the twin screws 260 further down the extrusion line to help promote better mixing with the blend of the first and second polyolefins 240, 244. A forced volatile organic compound (VOC) vacuum 264 may be used on the reactive twin screw extruder 252 to help maintain a desired reaction pressure. The twin screw extruder 252 is considered reactive because the radical initiator and silane crosslinker are reacting with and forming new covalent bonds with both the first and second polyolefins 240, 244. The melted silane-grafted polyolefin blend can exit the reactive twin screw extruder 252 using a gear pump 268 that injects the molten silane-grafted polyolefin blend into a water pelletizer 272 that can form a pelletized silane-grafted polyolefin blend 276. In some aspects, the molten silane-grafted polyolefin blend 276 may be extruded into pellets, pillows, or any other configuration prior to the incorporation of the condensation catalyst 280 (see FIG. 4B) and formation of the final article (e.g., a roofing membrane 10 as depicted in FIG. 1).

The reactive twin screw extruder 252 may be configured to have a plurality of different temperature zones (e.g., Z0-Z12 as shown in FIG. 4A) that extend for various lengths of the twin screw extruder 252. In some aspects, the respective temperature zones may have temperatures ranging from about room temperature to about 180° C., from about 120° C. to about 170° C., from about 120° C. to about 160° C., from about 120° C. to about 150° C., from about 120° C. to about 140° C., from about 120° C. to about 130° C., from about 130° C. to about 170° C., from about 130° C. to about 160° C., from about 130° C. to about 150° C., from about 130° C. to about 140° C., from about 140° C. to about 170° C., from about 140° C. to about 160° C., from about 140° C. to about 150° C., from about 150° C. to about 170° C., and from about 150° C. to about 160° C. In some aspects, Z0 may have a temperature from about 60° C. to about 110° C. or no cooling; Z1 may have a temperature from about 120° C. to about 130° C.; Z2 may have a temperature from about 140° C. to about 150° C.; Z3 may have a temperature from about 150° C. to about 160° C.; Z4 may have a temperature from about 150° C. to about 160° C.; Z5 may have a temperature from about 150° C. to about 160° C.; Z6 may have a temperature from about 150° C. to about 160° C.; Z7 may have a temperature from about 150° C. to about 160° C.; and Z8-Z12 may have a temperature from about 150° C. to about 160° C.

In some aspects, the number average molecular weight of the silane-grafted polyolefin elastomers may be in the range of from about 4,000 g/mol to about 30,000 g/mol, including from about 5,000 g/mol to about 25,000 g/mol and from about 6,000 g/mol to about 14,000 g/mol. The weight average molecular weight of the grafted polymers may be from about 8,000 g/mol to about 60,000 g/mol, including from about 10,000 g/mol to about 30,000 g/mol.

Referring now to FIGS. 3 and 4B, the method 200 next includes a step 208 of extruding the silane-grafted polyolefin blend 276 and the condensation catalyst 280 together to form a silane-crosslinkable polyolefin blend 298. In some aspects, one or more optional additives 284 may be added with the silane-grafted polyolefin blend 276 and the condensation catalyst 280 to adjust the final material properties of the silane-crosslinkable polyolefin blend 298. In step 208, the silane-grafted polyolefin blend 276 is mixed with a silanol forming condensation catalyst 280 to form reactive silanol groups on the silane grafts that can subsequently crosslink when exposed to humidity and/or heat.

In some aspects, the condensation catalyst 280 may include a mixture of sulfonic acid, antioxidant, process aide, and carbon black for coloring where the ambient moisture is sufficient for this condensation catalyst 280 to crosslink the silane-crosslinkable polyolefin blend 298 over a longer time period (e.g., about 48 hours). The silane-grafted polyolefin blend 276 and the condensation catalyst 280 may be added to a reactive single screw extruder 288 using an addition hopper (similar to addition hopper 256 shown in FIG. 4A) and an addition gear pump 296. The combination of the silane-grafted polyolefin blend 276 and the condensation catalyst 280, and in some aspects one or more optional additives 284, may be added to a single screw 292 of the reactive single screw extruder 288. The single screw extruder 288 is considered reactive because the silane-grafted polyolefin blend 276 and the condensation catalyst 280 are melted and combined together to mix the condensation catalyst 280 thoroughly and evenly throughout the melted silane-grafted polyolefin blend 276. The melted silane-crosslinkable polyolefin blend 298, as formed in step 208, can exit the reactive single screw extruder 288 through a die that can inject the molten silane-crosslinkable polyolefin blend 298 into the form of an uncured roofing membrane element.

During step 208, as the silane-grafted polyolefin blend 276 is extruded together with the condensation catalyst 280 to form the silane-crosslinkable polyolefin blend 298, a certain amount of crosslinking may occur. In some aspects, the silane-crosslinkable polyolefin blend 298 may be about 25% cured, about 30% cured, about 35% cured, about 40% cured, about 45% cured, about 50% cured, about 55% cured, about 60% cured, bout 65% cured, or about 70% cured, where a gel test (ASTM D2765) can be used to determine the amount of crosslinking in the final silane-crosslinked polyolefin elastomer. The silane-crosslinkable polyolefin blend 298 may be about 25 to 70, 35 to 60, or 45 to 50% cured. The silane-crosslinkable polyolefin blend 298 may be about 25, 30, 35, 40, 45, 50, 55, 60, 65, or 70 to 70% cured.

The final product may be highly cross-linked, having a gel content of about, at least about, or more than about 70 to 95, 72 to 90, or 75 to 88%, measured according to ASTM D2765. The final product may be highly cross-linked, having a gel content of about, at least about, or more than about 70, 71, 72, 73, 74, 75, 76, 77, 78, 79, 80, 81, 82, 83, 84, 85, 86, 87, 88, 89, 90, 91, 92, 93, 94, 95, or more %.

The final product may be lightly cross-linked, having a gel content of about, at least about, or at most about 40 to 70, 45 to 65, or 50 to 60%, measured according to ASTM D2765. The final product may be lightly cross-linked, having a gel content of about, at least about, or at most about 40, 42, 44, 46, 48, 50, 52, 54, 56, 58, 60, 62, 64, 68, or 70%.

Referring to FIGS. 3 and 4B, the method 200 further includes a step 212 of extruding and/or calendaring the silane-crosslinkable polyolefin elastomer or blend 298 to form the top and bottom layers 14, 38, as comprising the uncured silane-crosslinkable polyolefin elastomer. The silane-crosslinkable polyolefin elastomer or blend 298 is in a melted or molten state where it can flow and be shaped as it exits the reactive single screw extruder 288. A calendar system 302 is a device having two or more rollers (the area between the rollers is called a nip) used to process the melted silane-crosslinkable polyolefin elastomer blend 298 into a sheet or film. As the melted silane-crosslinkable polyolefin elastomer blend 298 leaves the reactive single screw extruder 288, it forms a pool of silane-crosslinkable polyolefin elastomer 306 at a first nip point of the calendar system 302. The pool of silane-crosslinkable polyolefin elastomer 306 is then pressed or rolled into the top or bottom layer 14, 38 respectively. The scrim layer 26 may be added to the top or bottom layer 14, 38, respectively, at any point during the calendaring process using a scrim roll 318. The scrim layer 26, as coupled to the top or bottom layer 14, 38, forms a partial scrim membrane 322. The partial scrim membrane 322 may be further calendared and pressed with the respectively missing top or bottom layer 14, 38 to form the uncured roofing membrane element.

Referring again to FIG. 3, the method 200 may further include a step 216 of crosslinking the silane-crosslinkable polyolefin blend 298 or the roofing membrane element in an uncured form at an ambient temperature and/or an ambient humidity to form the roofing membrane 10 (FIG. 1). More particularly, in this crosslinking process, the water hydrolyzes the silane of the silane-crosslinkable polyolefin elastomer to produce a silanol. The silanol groups on various silane grafts can then be condensed to form intermolecular, irreversible Si—O—Si crosslink sites. The amount of crosslinked silane groups, and thus the final polymer properties, can be regulated by controlling the production process, including the amount of catalyst used, as was explained above.

The crosslinking/curing of step 216 of the method 200 (see FIG. 3) may occur over a time period of from greater than 0 to about 20 hours. In some aspects, curing takes place over a time period of from about 1 hour to about 20 hours, 10 hours to about 20 hours, from about 15 hours to about 20 hours, from about 5 hours to about 15 hours, from about 1 hour to about 8 hours, or from about 3 hours to about 6 hours. The temperature during the crosslinking/curing may be about room temperature, from about 20° C. to about 25° C., from about 20° C. to about 150° C., from about 25° C. to about 100° C., or from about 20° C. to about 75° C. The humidity during curing may be from about 30% to about 100%, from about 40% to about 100%, or from about 50% to about 100%.

In some aspects, an extruder setting is used that is capable of extruding thermoplastic, with long L/D, 30 to 1, at an extruder heat setting close to TPV processing conditions where the extrudate crosslinks at ambient conditions, becoming a thermoset in properties. In other aspects, this process may be accelerated by steam exposure. Immediately after extrusion, the gel content (also called the crosslink density) may be about 60%, but after 96 hrs at ambient conditions, the gel content may reach greater than about 95%.

In some aspects, one or more reactive single screw extruders 288 may be used to form the uncured roofing membrane element (and corresponding roofing membrane 10) that has one or more types of silane-crosslinked polyolefin elastomers. For example, in some aspects, one reactive single screw extruder 288 may be used to produce and extrude a first silane-crosslinked polyolefin elastomer associated employed in a top layer 14 of a roofing membrane 10 (FIG. 1), while a second reactive single screw extruder 288 may be used to produce and extrude a second silane-crosslinked polyolefin elastomer employed in a bottom layer 38 of the roofing membrane 10. The complexity, architecture, and property requirements of the roofing membrane 10 will determine the number and types of reactive single screw extruder 288 suitable to fabricate it.

It is understood that the prior description outlining and teaching the various roofing membranes 10, and their respective components and compositions, can be used in any combination, and applies equally well to the method 200 for making the roofing membrane 10 using the two-step Sioplas process as shown in FIGS. 3, 4A and 4B.

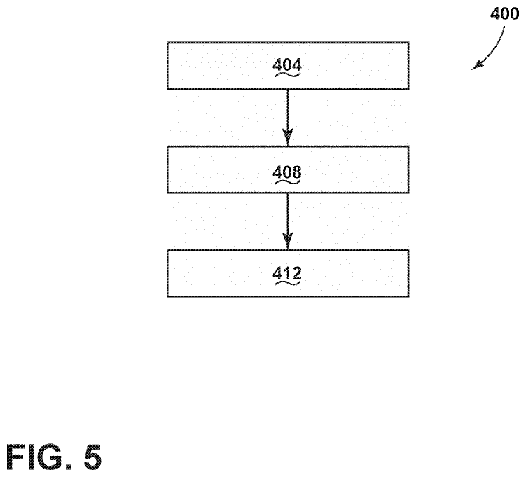

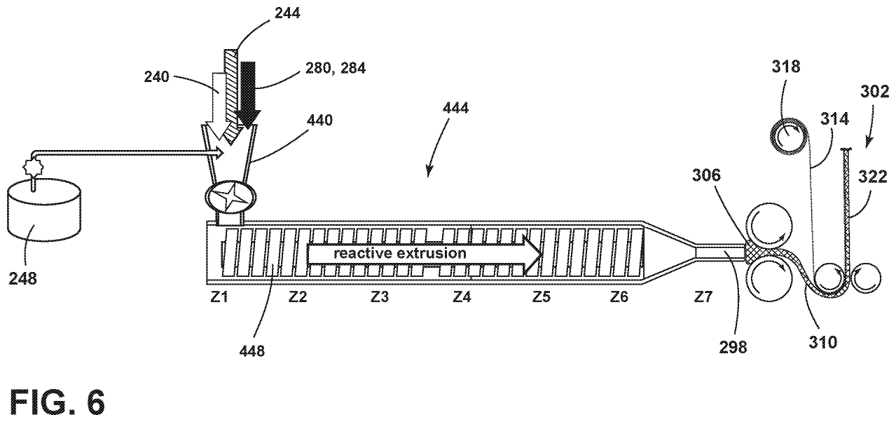

Referring now to FIGS. 5 and 6, a method 400 for making the roofing membrane 10 using the one-step Monosil process is shown. The method 400 may begin with a step 404 that includes extruding (e.g., with a single screw extruder 444) the first polyolefin 240 having a density less than 0.86 g/cm³, the second polyolefin 244, the silane cocktail 248 including the silane crosslinker (e.g., vinyltrimethoxy silane, VTMO) and grafting initiator (e.g. dicumyl peroxide), and the condensation catalyst 280 together to form the crosslinkable silane-grafted polyolefin blend 298.

The first polyolefin 240, second polyolefin 244, and silane cocktail 248 may be added to the reactive single screw extruder 444 using an addition hopper 440. In some aspects, the silane cocktail 248 may be added to a single screw 448 further down the extrusion line to help promote better mixing with the first and second polyolefin 240, 244 blend. In some aspects, one or more optional additives 284 may be added with the first polyolefin 240, second polyolefin 244, condensation catalyst 280 and silane cocktail 248 to adjust the final material properties of the silane-crosslinkable polyolefin blend 298.

The single screw extruder 444 is considered reactive because the grafting initiator and silane crosslinker of the silane cocktail 248 are reacting with and forming new covalent bonds with both the first and second polyolefins 240, 244. In addition, the reactive single screw extruder 444 mixes the condensation catalyst 280 in together with the melted silane-grafted polyolefin blend including the first and second polyolefins 240, 244, silane cocktail 248 and any optional additives 284. The resulting melted silane-crosslinkable polyolefin blend 298 can exit the reactive single screw extruder 444 using a gear pump (not shown) and/or die that can eject the molten silane-crosslinkable polyolefin blend 298 into the form of an uncured roofing membrane element.

During step 404, as the first polyolefin 240, second polyolefin 244, silane cocktail 248, and condensation catalyst 280 are extruded together, a certain amount of crosslinking may occur in the reactive single screw extruder 444 to the silane-crosslinkable blend 298. In some aspects, the silane-crosslinkable polyolefin blend 298 may be about 25% cured, about 30% cured, about 35% cured, about 40% cured, about 45% cured, about 50% cured, about 55% cured, about 60% cured, bout 65% cured, or about 70% as it leaves the reactive single screw extruder 444. The gel test (ASTM D2765) can be used to determine the amount of crosslinking in the final silane-crosslinked polyolefin elastomer.

The reactive single screw extruder 444 can be configured to have a plurality of different temperature zones (e.g., Z0-Z7 as shown in FIG. 6) that extend for various lengths along the extruder. In some aspects, the respective temperature zones may have temperatures ranging from about room temperature to about 180° C., from about 120° C. to about 170° C., from about 120° C. to about 160° C., from about 120° C. to about 150° C., from about 120° C. to about 140° C., from about 120° C. to about 130° C., from about 130° C. to about 170° C., from about 130° C. to about 160° C., from about 130° C. to about 150° C., from about 130° C. to about 140° C., from about 140° C. to about 170° C., from about 140° C. to about 160° C., from about 140° C. to about 150° C., from about 150° C. to about 170° C., and from about 150° C. to about 160° C. In some aspects, Z0 may have a temperature from about 60° C. to about 110° C. or no cooling; Z1 may have a temperature from about 120° C. to about 130° C.; Z2 may have a temperature from about 140° C. to about 150° C.; Z3 may have a temperature from about 150° C. to about 160° C.; Z4 may have a temperature from about 150° C. to about 160° C.; Z5 may have a temperature from about 150° C. to about 160° C.; Z6 may have a temperature from about 150° C. to about 160° C.; and Z7 may have a temperature from about 150° C. to about 160° C.

In some aspects, the number average molecular weight of the silane-grafted polyolefin elastomers may be in the range of from about 4,000 g/mol to about 30,000 g/mol, including from about 5,000 g/mol to about 25,000 g/mol and from about 6,000 g/mol to about 14,000 g/mol. The weight average molecular weight of the grafted polymers may be from about 8,000 g/mol to about 60,000 g/mol, including from about 10,000 g/mol to about 30,000 g/mol.

Referring to FIGS. 5 and 6, the method 400 further includes a step 408 of extruding and/or calendaring the silane-crosslinkable polyolefin elastomer or blend 298 to form the top and bottom layers 14, 38, as including the uncured silane-crosslinkable polyolefin elastomer. The silane-crosslinkable polyolefin elastomer or blend 298 is in a melted or molten state where it can flow and be shaped as it exits the reactive single screw extruder 444. As previously mentioned, the calendar system 302 is a device having two or more rollers (the area between the rollers is called a nip) used to process the melted silane-crosslinkable polyolefin elastomer blend 298 into a sheet or film. As the melted silane-crosslinkable polyolefin elastomer blend 298 leaves the reactive single screw extruder 444, it forms a pool of silane-crosslinkable polyolefin elastomer 306 at a first nip point of the calendar system 302. The pool of silane-crosslinkable polyolefin elastomer 306 is then pressed or rolled into the top or bottom layer 14, 38, respectively. The scrim layer 26 may be added to the top or bottom layer 14, 38 respectively at any point during the calendaring process using a scrim roll 318. The scrim layer 26, as coupled to the top or bottom layer 14, 38, forms a partial scrim membrane 322. The partial scrim membrane 322 may be further calendared and pressed with the respectively missing top or bottom layer 14, 38 to form an uncured roofing membrane element.

Still referring to FIG. 5, the method 400 can further include a step 412 of crosslinking the silane-crosslinkable polyolefin blend 298 of the uncured roofing membrane element at an ambient temperature and an ambient humidity to form the element into the roofing membrane 10 (FIG. 1). The amount of crosslinked silane groups, and thus the final polymer properties of the roofing membrane 10, can be regulated by controlling the production process, including the amount of catalyst used.

The step 412 of crosslinking the silane-crosslinkable polyolefin blend 298 may occur over a time period of from greater than 0 to about 20 hours. In some aspects, curing takes place over a time period of from about 1 hour to about 20 hours, 10 hours to about 20 hours, from about 15 hours to about 20 hours, from about 5 hours to about 15 hours, from about 1 hour to about 8 hours, or from about 3 hours to about 6 hours. The temperature during the crosslinking and curing may be about room temperature, from about 20° C. to about 25° C., from about 20° C. to about 150° C., from about 25° C. to about 100° C., or from about 20° C. to about 75° C. The humidity during curing may be from about 30% to about 100%, from about 40% to about 100%, or from about 50% to about 100%.

In some aspects, an extruder setting is used that is capable of extruding thermoplastic, with long L/D, 30 to 1, at an extruder heat setting close to TPV processing conditions where the extrudate crosslinks at ambient conditions, becoming a thermoset in properties. In other aspects, this process may be accelerated by steam exposure. Immediately after extrusion, the gel content (also called the crosslink density) may be about 60%, but after 96 hrs at ambient conditions, the gel content may reach greater than about 95%.

In some aspects, one or more reactive single screw extruders 444 may be used to form the roofing membrane 10 that has one or more types of silane-crosslinked polyolefin elastomers. For example, in some aspects, one reactive single screw extruder 444 may be used to produce and extrude a first silane-crosslinked polyolefin elastomer associated with the top layer 14 of the roofing membrane 10 (FIG. 1), while a second reactive single screw extruder 444 may be used to produce and extrude a second silane-crosslinked polyolefin elastomer associated with the bottom layer 38 of the roofing membrane 10. The complexity, architecture, and required properties of the final roofing membrane 10 may determine the number and types of reactive single screw extruders 444 employed according to the method 400 depicted in FIG. 5.

It is understood that the prior description outlining and teaching of the various roofing membranes 10, and their respective components and compositions, may be used in any combination, and applies equally well to the method 400 for making the roofing membrane 10 using the one-step Monosil process as shown in FIGS. 5 and 6. Additionally, the roofing membrane disclosed herein may be prepared by alternative processes.

A “thermoplastic”, as used herein, is defined to mean a polymer that softens when exposed to heat and returns to its original condition when cooled to room temperature. A “thermoset”, as used herein, is defined to mean a polymer that solidifies and irreversibly “sets” or “crosslinks” when cured. In either of the Monosil or Sioplas processes described above, it is important to understand the careful balance of thermoplastic and thermoset properties of the various different materials used to produce the final thermoset silane-crosslinked polyolefin elastomer or roofing membrane. Each of the intermediate polymer materials mixed and reacted using a reactive twin screw extruder, and/or a reactive single screw extruder are thermosets. Accordingly, the silane-grafted polyolefin blend 276 and the silane-crosslinkable polyolefin blend 298 are thermoplastics and can be softened by heating so the respective materials can flow. Once the silane-crosslinkable polyolefin blend 298 is extruded, molded, pressed, and/or shaped into the uncured roofing membrane element or other respective article, the silane-crosslinkable polyolefin blend 298 can begin to crosslink or cure at an ambient temperature and an ambient humidity to form the roofing membrane 10 (or other end product form), as comprising one or more silane-crosslinked polyolefin blends.

The thermoplastic/thermoset behavior of the silane-crosslinkable polyolefin blend 298 and corresponding silane-crosslinked polyolefin blend are important for the various compositions and articles disclosed herein (e.g., roofing membrane 10 shown in FIG. 1) because of the potential energy savings provided using these materials. For example, a manufacturer can save considerable amounts of energy by being able to cure the silane-crosslinkable polyolefin blend 298 at an ambient temperature and an ambient humidity. This curing process is typically performed in the industry by applying significant amounts of energy to heat or steam treat crosslinkable polyolefins 298. The ability to cure the inventive silane-crosslinkable polyolefin blend 298 with ambient temperature and/or ambient humidity is not a capability necessarily intrinsic to crosslinkable polyolefins. Rather, this capability or property is dependent on the relatively low density of the silane-crosslinkable polyolefin blend 298. In some aspects, no additional curing ovens, heating ovens, steam ovens, or other forms of heat producing machinery other than what was provided in the extruders are used to form the silane-crosslinked polyolefin elastomers.

The specific gravity of the silane-crosslinked polyolefin elastomer of the present disclosure may be lower than the specific gravities of existing TPV and EPDM formulations used in the art. The reduced specific gravity of these materials can lead to lower weight parts, thereby facilitating additional ease-of-assembly for roofers and other individuals charged with installing the roofing membranes 10 of the disclosure. For example, the specific gravity of the silane-crosslinked polyolefin elastomer of the present disclosure may be from about 0.80 g/cm³ to about 1.50 g/cm³, from about 1.25 g/cm³ to about 1.45 g/cm³, from about 1.30 g/cm³ to about 1.40 g/cm³, about 1.25 g/cm³, about 1.30 g/cm³, about 1.35 g/cm³, about 1.40 g/cm³, about 1.45 g/cm³, about 1.50 g/cm³, less than 1.75 g/cm³, less than 1.60 g/cm³, less than 1.50 g/cm³, or less than 1.45 g/cm³, as compared to conventional TPV materials which may have a specific gravity greater than 2.00 g/cm³ and conventional EPDM materials which may have a specific gravity of from 2.0 g/cm³ to 3.0 g/cm³. The specific gravity of the composition may be about, at least about, or no more than about 0.8 to 2.0, 1.0 to 1.9, or 1.25 to 1.85 g/cm³. The specific gravity of the composition may be about, at least about, or no more than about 0.8, 0.9, 1.0, 1.1, 1.2, 1.3, 1.4, 1.5, 1.6, 1.7, 1.8, 1.9 or 2.0 g/cm³.

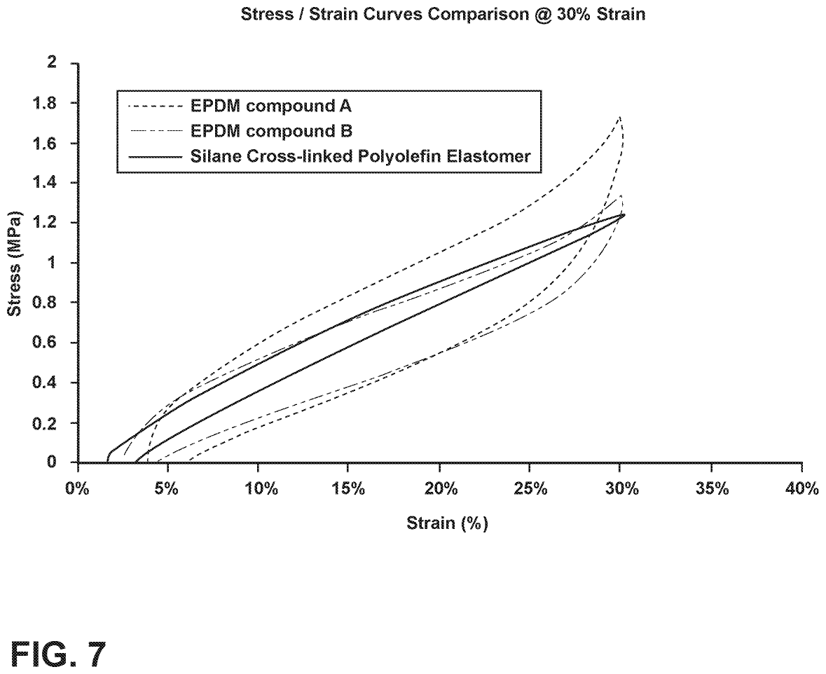

The stress/strain behavior of an exemplary silane-crosslinked polyolefin elastomer of the present disclosure (i.e., “silane-crosslinked polyolefin elastomer”) relative to two existing EPDM materials is provided. In particular, FIG. 7 displays a smaller area between the stress/strain curves for the silane-crosslinked polyolefin of the disclosure (labeled as “Silane Cross-linked Polyolefin Elastomer” in FIG. 7), as compared to the areas between the stress/strain curves of EPDM compound A and EPDM compound B. This smaller area between the stress/strain curves for the silane-crosslinked polyolefin elastomer can be desirable for roofing membranes 10. Elastomeric materials typically have non-linear stress/strain curves with a significant loss of energy when repeatedly stressed. The silane-crosslinked polyolefin elastomers of the present disclosure may exhibit greater elasticity and less viscoelasticity (e.g., have linear curves and exhibit very low energy loss). Embodiments of the silane-crosslinked polyolefin elastomers described herein do not have any filler or plasticizer incorporated into these materials so their corresponding stress/strain curves do not have or display any Mullins effect and/or Payne effect. The lack of Mullins effect for these silane-crosslinked polyolefin elastomers is due to the lack of any filler or plasticizer added to the silane-crosslinked polyolefin blend so the stress/strain curve does not depend on the maximum loading previously encountered where there is no instantaneous and irreversible softening. The lack of Payne effect for these silane-crosslinked polyolefin elastomers is due to the lack of any filler or plasticizer added to the silane-crosslinked polyolefin blend so the stress/strain curve does not depend on the small strain amplitudes previously encountered where there is no change in the viscoelastic storage modulus based on the amplitude of the strain. The silane-crosslinked polyolefin elastomer or roofing membrane disclosed herein may exhibit a compression set of from about 5.0% to about 30.0%, from about 5.0% to about 25.0%, from about 5.0% to about 20.0%, from about 5.0% to about 15.0%, from about 5.0% to about 10.0%, from about 10.0% to about 25.0%, from about 10.0% to about 20.0%, from about 10.0% to about 15.0%, from about 15.0% to about 30.0%, from about 15.0% to about 25.0%, from about 15.0% to about 20.0%, from about 20.0% to about 30.0%, or from about 20.0% to about 25.0%, as measured according to ASTM D 395 (22 hrs at 23° C., 70° C., 80° C., 90° C., 125° C., and/or 175° C.). The silane-crosslinked polyolefin elastomer or roofing membrane disclosed herein may exhibit a compression set of from about 5.0% to about 20.0%, from about 5.0% to about 15.0%, from about 5.0% to about 10.0%, from about 7.0% to about 20.0%, from about 7.0% to about 15.0%, from about 7.0% to about 10.0%, from about 9.0% to about 20.0%, from about 9.0% to about 15.0%, from about 9.0% to about 10.0%, from about 10.0% to about 20.0%, from about 10.0% to about 15.0%, from about 12.0% to about 20.0%, or from about 12.0% to about 15.0%, as measured according to ASTM D 395 (22 hrs @ 23° C., 70° C., 80° C., 90° C., 125° C., and/or 175° C.).

The roofing membrane may have a compression set of about, at least about, or at most about 50 to 90, 60 to 85, or 70 to 80% measured at 70° C./22 hr according to ASTM D 395. The roofing membrane may have a compression set of about, at least about, or at most about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90% measured at 70° C./22 hr according to ASTM D 395.

The silane-crosslinked polyolefin elastomer or roofing membrane disclosed herein may exhibit a crystallinity of from about 5% to about 40%, from about 5% to about 25%, from about 5% to about 15%, from about 10% to about 20%, from about 10% to about 15%, or from about 11% to about 14% as determined using density measurements, differential scanning calorimetry (DSC), X-Ray Diffraction, infrared spectroscopy, and/or solid state nuclear magnetic spectroscopy. As disclosed herein, DSC was used to measure the enthalpy of melting to calculate the crystallinity of the respective samples. The roofing membrane may have crystallinity of about, at least about, or at most about 2 to 10, 3.5 to 8, or 4 to 6%, measured by DSC. The roofing membrane may have crystallinity of about, at least about, or at most about 2, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, or 10.0%, measured by DSC.

The silane-crosslinked polyolefin elastomer or roofing membrane disclosed herein may exhibit a glass transition temperature of from about −75° C. to about −25° C., from about −65° C. to about −40° C., from about −60° C. to about −50° C., from about −50° C. to about −25° C., from about −50° C. to about −30° C., or from about −45° C. to about −25° C. as measured according to differential scanning calorimetry (DSC) using a second heating run at a rate of 5° C./min or 10° C./min. The roofing membrane may have glass transition temperature of about, at least about, or at most about −25 to −75, −30 to −60, or −35 to −50° C.

The silane-crosslinked polyolefin elastomer or roofing membrane disclosed herein may exhibit a weathering color difference of from about 0.25 ΔE to about 2.0 ΔE, from about 0.25 ΔE to about 1.5 ΔE, from about 0.25 ΔE to about 1.0 ΔE, or from about 0.25 ΔE to about 0.5 ΔE, as measured according to ASTM D2244. In some embodiments, the roofing membrane disclosed herein may be a high-load flame retardant thermoplastic polyolefin (TPO) having the above weathering properties.

The silane-crosslinked polyolefin elastomer or roofing membrane disclosed herein may have tensile strength at break, measured according to the ASTM D412, Die C testing method, of about, at least about, or at most about 9 to 15, 9.5 to 14, or 10 to 12 MPa. The roofing membrane may have tensile strength at break of about, at least about, or at most about 9, 9.5, 10, 10.5, 11, 11.5, 12, 12.5, 13, 13.5, 14, 14.5, or 15 MPa.

The silane-crosslinked polyolefin elastomer or roofing membrane disclosed herein may have dynamic puncture resistance, measured according to the ASTM D5635/D5635M testing method, of about, at least about, or at most about 15.5 to 25, 16 to 23, or 16.5 to 22.5. The dynamic puncture resistance relates to the relative ability of the roofing membrane to inhibit the intrusion of a foreign object. The roofing membrane may have dynamic puncture resistance of about, at least about, or at most about 15.5, 16, 16.5, 17, 17.5, 18, 18.5, 19, 19.5, 20, 20.5, 21, 21.5, 22, 22.5, 23, 23.5, 24, 24.5, or 25.

The silane-crosslinked polyolefin elastomer or roofing membrane disclosed herein may have tear resistance, measured according to ASTM D624, Die C method, of about, at least about, or at most about 30 to 50, 35 to 48, or 38 to 46 kN/m. The roofing membrane may have tear resistance of about, at least about, or at most about 30, 31, 32, 33, 34, 35, 36, 37, 38, 39, 40, 41, 42, 43, 44, 45, 46, 47, 48, 49, or 50 kN/m.

The silane-crosslinked polyolefin elastomer or roofing membrane disclosed herein may have tearing strength, measured according to ASTM D751, B-Tongue Tear, method, of about, at least about, or at most about 114 to 350, 140 to 300, or 150 to 280. The roofing membrane may have tearing strength of about, at least about, or at most about 114, 120, 130, 140, 150, 160, 170, 180, 190, 200, 210, 220, 230, 240, 250, 260, 270, 280, 290, 300, 310, 320, 330, 340, or 350.

The silane-crosslinked polyolefin elastomer or roofing membrane disclosed herein may have tensile elongation at break, measured according to the ASTM D412, Die C testing method, of about, at least about, or at most about 600 to 930, 630 to 900, or 700 to 860%. The roofing membrane may have tensile elongation at break of about, at least about, or at most about 600, 630, 660, 690, 700, 730, 760, 790, 800, 830, 860, 890, 900, or 930%.

The silane-crosslinked polyolefin elastomer or roofing membrane disclosed herein may have thermal retraction (TR), measured according to the ISO 2921 testing method, of about, at least about, or at most about −35 to −29, −32 to −28, or −30 to −25% at TR10 and/or −12 to −5, −11.5 to −8, or −10.9 to −9.5% at TR30. The roofing membrane may have TR of about, at least about, or at most about −35, −34.5, −34, −33.5, −33, −32.5, −32, −31.5, −31, −30.5, −30, −29.5, −29, −28.5, −28, −27.5, −27, −26.5, −26, −25.5, or −25% at TR10 and/or −12, −11.5, −11, −10.5, −10, −9.5, −9, −8.5, −8, −7.5, −7, −6.5, −6, −5.5, or −5% at TR30.

The silane-crosslinked polyolefin elastomer or roofing membrane disclosed herein may have long chain branching (LCB) index (S′) and/or (G′) of about, at least about, or at most about 1 to 2.8, 1.2 to 2.6, or 1.4 to 2.4. The roofing membrane may have LCB index (S′) and/or (G′) of about, at least about, or at most about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, or 2.8.

The silane-crosslinked polyolefin elastomer or roofing membrane disclosed herein may have relative modulus (RM), measured according to ASTM D1053 method, of about, at least about, or at most about −18 to −5, −17 to −7.5, or −16 to −10. The roofing membrane may have RM of about, at least about, or at most about −5, −5.5, −6, −6.5, −7, −7.5, −8, −8.5, −9, −9.5, −10, −10.5, −11, −11.5, −12, −12.5, −13, −13.5, −14, −14.5, −15, −15.5, −16, −16.5, −17, −17.5, or −18.

The silane-crosslinked polyolefin elastomer or roofing membrane disclosed herein may have brittleness point, measured according to ASTM D2137 method, of about, at least about, or at most about −70 to −45, −69 to −50, or −68 to −55° C. The roofing membrane may have brittleness point of about, at least about, or at most about −70, −69, −68, −67, −66, −65, −64, −63, −62, −61, −60, −59, −58, −57, −56, −55, −54, −53, −52, −51, −50, −49, −48, −47, −46, or −45° C.

Under heat ageing testing according to ASTM D573, silane-crosslinked polyolefin elastomer or roofing membrane disclosed herein may have tensile strength of about, at least about, or at most about 8.3 to 11.0, 8.5 to 10.8, or 9.0 to 10.2 MPa. The heat ageing tensile strength of the silane-crosslinked polyolefin elastomer or roofing membrane may be about, at least about, or at most about 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, or 11.0.

Under heat ageing testing according to ASTM D573, silane-crosslinked polyolefin elastomer or roofing membrane disclosed herein may have elongation of about, at least about, or at most about 350 to 700, 400 to 550, or 600 to 680%. The heat ageing elongation of the silane-crosslinked polyolefin elastomer or roofing membrane may be about, at least about, or at most about 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690 or 700%.

Under heat ageing testing according to ASTM D573, silane-crosslinked polyolefin elastomer or roofing membrane disclosed herein may have tear resistance of about, at least about, or at most about 22 to 45, 30 to 44, or 35 to 43 kN/m. The heat ageing tear resistance of the silane-crosslinked polyolefin elastomer or roofing membrane may be about, at least about, or at most about 22, 23, 24, 25, 26, 27, 28, 29, 30, 31, 32, 33, 34, 35, 36, 37, 38, 39, 40, 41, 42, 43, 44, or 45 kN/m.

Under heat ageing testing according to ASTM D573, 6 hr at 70° C., silane-crosslinked polyolefin elastomer or roofing membrane disclosed herein may have linear dimensional change of about, at least about, or at most about ±0.1 to 1.6, 0.2 to 0.99, or 0.3 to 0.98%. The heat ageing linear dimensional change of the silane-crosslinked polyolefin elastomer or roofing membrane may be about, at least about, or at most about ±0.1, 0.2, 0.3, 0.4, 0.5, 0.6, 0.7, 0.8, 0.9, 1.0, 1.1, 1.2, 1.3, 1.4, 1.5, or 1.6%.

### EXAMPLES

The following non-limiting examples are provided to further outline aspects of the disclosure.

All chemicals, constituents and precursors were obtained from commercial suppliers and were used as provided without further purification.

### Example 1—Preparation of the Silane-Grafted Polyolefin Elastomer

Example 1 or ED76-4A was produced by extruding 82.55 wt. % ENGAG™ 8842 and 14.45 wt. % MOSTE™ TB 003 together with 3.0 wt. % SILAN RHS 14/032 or SILFIN 29 to form a silane-grafted polyolefin elastomer, according to one of the foregoing methods outlined in the disclosure. The Example 1 silane-grafted polyolefin elastomer was then extruded using various condensation catalysts and fillers to form a silane-crosslinkable polyolefin elastomer, as suitable for top and bottom layers 14, 38 of a roofing membrane (as described below in Example 2). The composition of the Example 1 silane-grafted polyolefin elastomer is provided in Table 1 below.

TABLE 1
Composition of Example 1

| | | Example 1 |
|---|---|---|
| Components | Description of Component | [wt. %] |
| ENGAGE | High performance ethylene-octene (EO) | 82.55 |
| 8842 | polyolefin elastomer, Density: 0.857 g/cm³, | |
| | MFR (190° C., 2.16 kg): 1 g/10 min | |
| MOSTEN | Polypropylene, MFR (230° C., 2.16 kg): | 14.45 |
| TB 003 | 3.2 g/10 min, Density: 900-920 kg/m³ | |
| SILFIN 29 | | 3.00 |
| TOTAL | | 100 |

### Example 2—Preparation of the Roofing Membrane

In this example, identical top and bottom layers 14, 38 were used to produce an embodiment of a roofing membrane 10. In particular, the top and bottom layers 14, 38 were produced by extruding 29.0 wt. % silane-grafted polyolefin elastomer (from Example 1) and 70.0 wt. % vinyl silane coated magnesium dihydroxide, Mg(OH)₂ (MDH), together with 1.0 wt. % dioctyltin dilaurate (DOTL) condensation catalyst to form a silane-crosslinkable polyolefin elastomer blend. The blend was then extruded and calendared to provide the respective top and bottom layers 14, 38 of an uncured roofing membrane element. The silane-crosslinkable polyolefin elastomer of the layers 14, 38 of the uncured roofing membrane element was then cured at ambient temperature and humidity to form the roofing membrane 10. The composition of the roofing membrane 10 formed in this example is provided in Table 2 below.

### Example 3—Preparation of the Roofing Membrane

In Example 3, identical top and bottom layers 14, 38 were used to produce another embodiment of a single ply roofing membrane 10. In particular, the top and bottom layers 14, 38 were produced by extruding 29.0 wt. % silane-grafted polyolefin elastomer (from Example 1) and 70.0 wt. % stearic acid coated magnesium dihydroxide, Mg(OH)₂ (MDH), together with 1.0 wt. % dioctyltin dilaurate (DOTL) condensation catalyst to form a silane-crosslinkable polyolefin elastomer blend. The blend was then extruded and calendared to provide the respective top and bottom layers 14, 38 of an uncured roofing membrane element. The silane-crosslinkable polyolefin elastomer of the layers 14, 38 of the uncured roofing membrane element was then cured at ambient temperature and humidity to form the roofing membrane 10. The composition of the roofing membrane 10 formed in this example is also provided in Table 2 below.

TABLE 2
Comparison of Examples 2 and 3

| | | | Vinyl | Stearic | |
|---|---|---|---|---|---|
| | | | Silane | Acid | |
| | | | coated | coated | DOTL |
| | | ED 76-4A | MDH | MDH | Catalyst |
| Example | Layer | [wt. %] | [wt. %] | ([wt. %]) | [wt. %] |
| Example 2 | Top Layer | 29 | 70 | — | 1 |
| Example 2 | Bottom Layer | 29 | 70 | — | 1 |
| Example 3 | Top Layer | 29 | — | 70 | 1 |
| Example 3 | Bottom Layer | 29 | — | 70 | 1 |

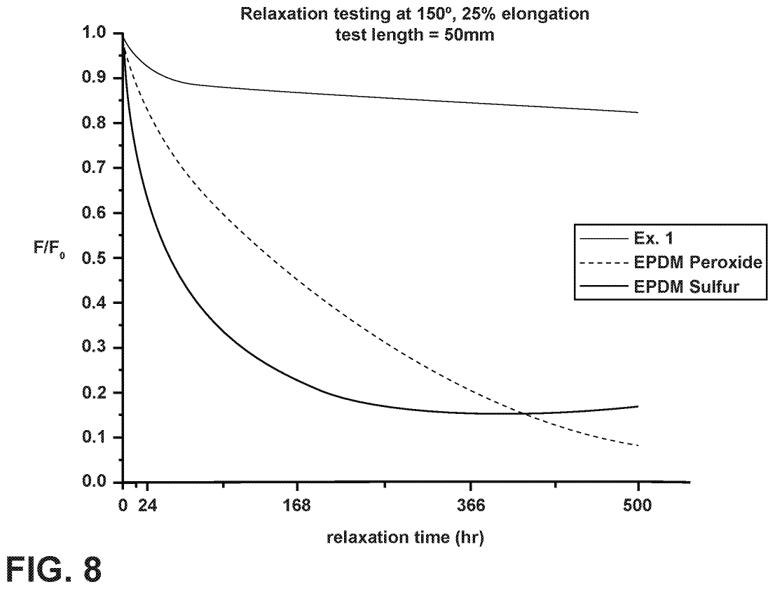

Referring now to FIG. 8, the thermal stability of Example 1 is provided with respect to a comparative EPDM peroxide crosslinked resin and a comparative EPDM sulfur crosslinked resin. As shown, Example 1 can retain nearly 90% of its elastic properties at 150° C. for greater than 500 hrs. The retention of elastic properties as provided in Example 1 is representative of each of the inventive silane-crosslinked polyolefin elastomers disclosed herein. The roofing member made from these silane-crosslinked polyolefin elastomers may retain up to 60%, 70%, 80%, or 90% of its elastic properties as determined by using Stress Relaxation measurements at 150° C. for greater than 100 hrs, greater than 200 hrs, greater than 300 hrs, greater than 400 hrs, and greater than 500 hrs.

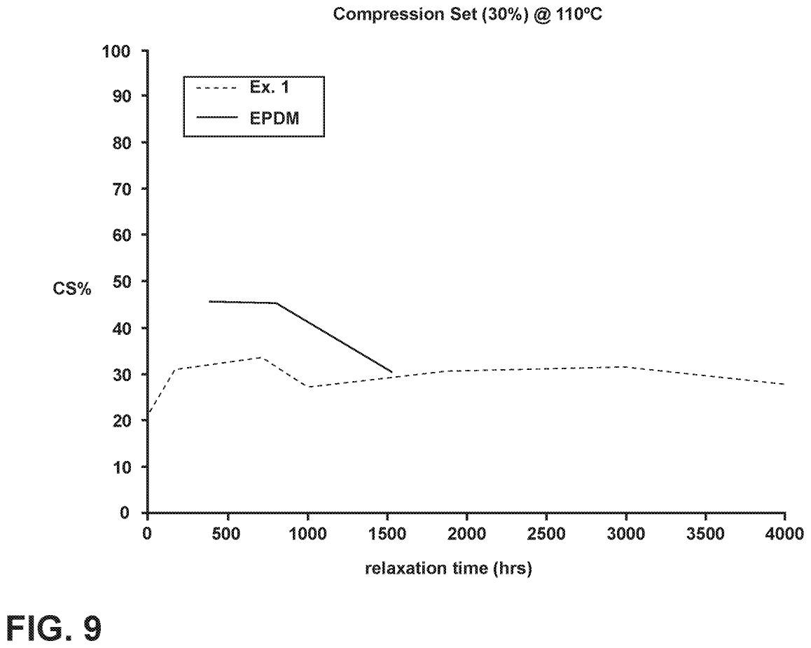

Referring now to FIG. 9, the compression set values are provided across a time period of 4,000 hrs for Example 1 that demonstrates the superior long-term retention of elastic properties of the silane-crosslinked polyolefin elastomer material used to make the roofing membrane 10. As provided, the Example 1 silane-crosslinked polyolefin elastomer material maintains a compression set of 35% or lower, as measured according to ASTM D 395 (30% @ 110° C.). The ability of these silane-crosslinked polyolefin elastomer materials used in roofing membranes 10 to retain its elasticity (compression set %) over a long period of time upon exposure to heat that simulates exterior weathering or aging is provided by this representative example of these roofing membrane 10 materials.

### Examples 4-6 and Comparative example A

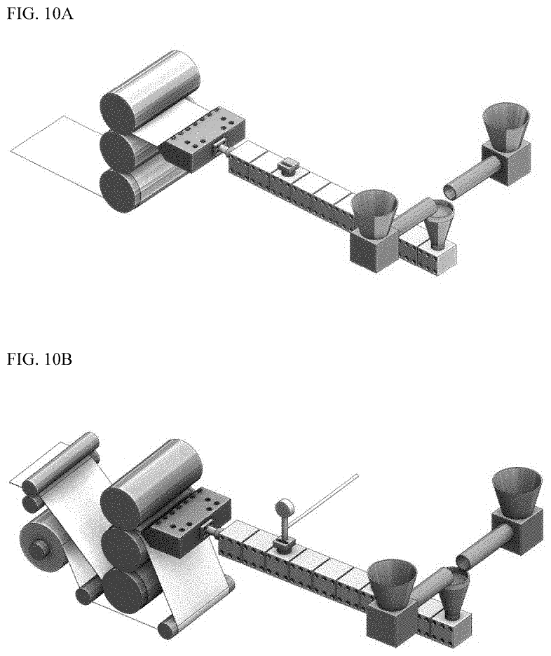

The Examples 4 and 5 were prepared in a twin-screw machine shown in FIG. 10A while Example 6 was made in the twin-screw machine of FIG. 10B. The pre-mixed or compounded components were fed into hopper with gravimetric feeder at certain speed, from about 25 lb/hr to 250 lb/hr. The barrel temperature was set in the range of 150-170° C. A gear pump was used before the slit die for stable extrusion and uniform thickness of Example membranes. The bottom layer of Example 6 was extruded first, followed by extrusion of the top layer. As soon as the top layer was produced, the pre-heated bottom membrane layer was brought to the 3-roll mill to be laminated with the top layer together. The pre-heat temperature was about 80° C. Each sample was prepared and tested three times. The values in Table 4 are average values.

TABLE 3
Composition of Examples 4-6 and Comparative example A in wt. %.

| | Example/Comparative example no. | | | | |
|---|---|---|---|---|---|
| | | | 6 - top | 6 - bottom | |
| | 4 | 5 | layer | layer | A |
| Component | [wt. %] | [wt. %] | [wt. %] | [wt. %] | [wt. %] |
| Ethylene-silane copolymer | — | — | — | — | 47.5 |
| MFR (190° C., 2.16 kg): 1.55 g/10 | | | | | |
| min, Density: 0.922 g/cm³ | | | | | |
| Ethylene-1-butene copolymer | 35 | — | 35 | 35 | — |
| ML1 + 4@121° C.: 20 MU, MFR | | | | | |
| (190° C., 2.16 kg): 1.2 g/10 min, | | | | | |
| Density: 0.862 g/cm³, Shore A: 46 | | | | | |
| Ethylene propylene copolymer | 6.5 | 5 | 6.5 | 1.5 | 5 |
| MFR (230° C., 2.16 kg): 25 g/10 | | | | | |
| min, Density: 0.868 g/cm³, Shore | | | | | |
| A: 84, Total crystallinity: 16%) | | | | | |
| Ethylene-octene copolymers | 12.5 | — | 12.5 | 12.5 | — |
| ML1 + 4@121° C.: 10, MFR | | | | | |
| (190°C, 2.16 kg): 3.0 g/10 min, | | | | | |
| Density: 0.902 g/cm³, Shore A: 90, | | | | | |
| Total crystallinity: 29%, Tensile | | | | | |
| strength at break: 22.4 MPa | | | | | |
| Ethylene-1-octene copolymer | — | 49.5 | — | — | — |
| MFR (190° C., 2.16 kg): 3.0 g/10 | | | | | |
| min, Density: 0.902 g/cm³, Tensile | | | | | |
| strength at break: 64-73 MPa | | | | | |
| Ethylene-octene copolymer | 2.585 | 2.585 | 2.585 | — | 2.585 |
| ML1 + 4@121° C.: 2, MFR (190° C., | | | | | |
| 2.16 kg): 30 g/10 min, Density: | | | | | |
| 0.885 g/cm³, Shore A: 84, Total | | | | | |
| crystallinity: 25%, Tensile strength | | | | | |
| at break: 8.5 MPa | | | | | |
| Ethylene based octene-1 plastomer | — | — | — | 5.75 | — |
| MFR (190° C., 2.16 kg): 3.0 g/10 | | | | | |
| min, Density: 0.883 g/cm³, Shore | | | | | |
| A: 85, Total crystallinity: 25%, | | | | | |
| Tensile strength at break: 22 MPa | | | | | |
| Ethylene-1-butene copolymer | — | — | — | 14.5 | — |
| ML1 + 4@121° C.: 8, MFR (190° C., | | | | | |
| 2.16 kg): 5.0 g/10 min, Density: | | | | | |
| 0.865 g/cm³, Shore A: 54, Tensile | | | | | |
| strength at break: 1.8 MPa | | | | | |
| LDPE | — | — | — | — | 2.5 |
| MFR (190° C., 2.16 kg): 20 | | | | | |
| Random copolymer of Ethylene | 4.065 | 4.065 | 4.065 | — | 4.065 |
| and Butyl Acrylate | | | | | |
| Butyl Acrylate content of 16-19 | | | | | |
| wt. %; MFR (190° C, 2.16 kg): 6.5- | | | | | |
| 8 g/10 min; Density (23° C.): 0.93 | | | | | |
| g/cm³, Shore A: 88 | | | | | |
| Vinyl silane-peroxide mixture | 1 | 0.5 | 1 | 1 | — |
| Light stabilizer | 1 | 1 | 1 | 1 | 1 |
| Antioxidant | 0.06 | 0.06 | 0.06 | 1.25 | 0.06 |
| Process or secondary stabilizer | 0.02 | 0.02 | 0.02 | 0.02 | 0.02 |
| Acid scavenger and stabilizer for | 0.005 | 0.005 | 0.005 | 0.005 | — |
| polyolefins | | | | | |
| Slip agent | 0.81 | 0.81 | 0.81 | 2.5 | 0.81 |
| Siloxane masterbatch | 0.9 | 0.9 | 0.9 | 0.9 | 0.9 |
| High-purity magnesium hydroxide | 32.5 | 32.5 | 32.5 | — | 32.5 |
| surface treated with a special vinyl | | | | | |
| silane coating | | | | | |
| Titanium dioxide | 3.04 | 3.04 | 3.04 | — | 3.04 |
| Catalyst: dioctyltin dilaurate | 0.015 | 0.015 | 0.015 | 0.015 | 0.015 |
| Calcium carbonate, small particle | — | — | — | 20 | — |
| size | | | | | |
| Carbon black | — | — | — | 4.065 | — |
| Total wt. % | 100 | 100 | 100 | 100 | 100 |

Examples 4-6 and Comparative Example A were tested in comparison to a typical commercially available EPDM rubber roofing membrane sample. The results of the tested physical and rheological properties are provided in Table 4 below.

TABLE 4
Physical and rheological properties of Examples 4-6, Comparative
Example A, and an EPDM roofing membrane sample

| | Example/Comparative example no./Sample | | | | |
|---|---|---|---|---|---|
| | | | | | EPDM |
| Measured Property | | | | | membrane |
| [unit] | 4 | 5 | 6 | A | sample |
| Tensile Strength Break | 11.3 | 14.86 | 9.6 | 10.67 | 10.4 |
| [MPa], ASTM D412 Die C | | | | | |
| Tensile Elongation Break | 918 | 631 | 772 | 109 | 448 |
| [%], ASTM D412 Die C | | | | | |
| Compression Set, 70° C./22 | 67.4 | 80.7 | — | 61.7 | 15.9 |
| hr, ASTM D 395 | | | | | |

Thermal Retraction (TR) [%], ISO 2921:

| | | | | | |
|---|---|---|---|---|---|
| TR 10 | −30.7 | — | −30.7 | −24.6 | −17.3 |
| TR 30 | −11.6 | — | −10.9 | −0.7 | −2.7 |
| TR 50 | 0.4 | — | 0.2 | 10.2 | 4.0 |
| TR 70 | 9.2 | — | 8.4 | — | 9.5 |
| Long Chain Branching | 2.58 | 1.18 | 2.58 | 4.63 | — |
| (LCB) Index (S′) | | | | | |
| Long Chain Branching | 2.61 | 1.15 | 2.61 | 4.58 | — |
| (LCB) Index (G′) | | | | | |

Relative Modulus (RM), ASTM D1053:

| | | | | | |
|---|---|---|---|---|---|
| RM 2 | −16.9 | — | −7.4 | 0.5 | −19.1 |
| RM 5 | −38.7 | — | −35.0 | −24.2 | −35.2 |
| RM 10 | −47.6 | — | −45.4 | −35.5 | −42.1 |
| RM 100 | −69.6 | — | −65.57 | −63.7 | −55.5 |

Hysteresis analysis:

| | | | | | |
|---|---|---|---|---|---|
| Energy loss in 1^{st} cycle | 0.0000 | — | — | 0.0067 | 0.0000 |
| Energy loss in 2^{nd} cycle | 0.0004 | — | — | 0.0434 | 0.0007 |
| Energy loss in 3^{rd} cycle | 0.0049 | — | — | 0.1017 | 0.0022 |
| Energy loss in 4^{th} cycle | 0.0160 | — | — | 0.2000 | 0.0050 |
| Energy loss in 5^{th} cycle | 0.0358 | — | — | 0.3483 | 0.0096 |
| Energy loss in 6^{th} cycle | 0.0629 | — | — | 0.5198 | 0.0163 |

Ageing - Stress Relaxation:

| | | | | | |
|---|---|---|---|---|---|
| Thickness [mm] | 1.29 | — | 1.30 | 1.90 | 1.19 |
| F/F0 Force at 4 hrs [%] | 67% | — | 90% | 48% | 60% |
| Ageing - Tensile Stress | 0.051 | — | 0.244 | 0.006 | 0.965 |
| [MPa] at 0 hr | | | | | |
| Ageing - Tensile Stress | 0.030 | — | 0.208 | 0.002 | 0.537 |
| [MPa] at 4 hr | | | | | |

Crystallinity:

| | | | | | |
|---|---|---|---|---|---|
| Enthalpy ΔHm [J/g] | 12.2 | — | 11.5 | 53.9 | 2.4 |
| % Crystallinity at Tₘ = | 4.2 | — | 3.9 | 18.4 | 0.8 |
| [ΔHₘ1/ΔHₘ100%]*100, | | | | | |
| ΔHₘ100% for LDPE = 293 J/g | | | | | |

Thermal Retraction (TR) testing was done according to ISO 2921 procedure on Elastocon TR Tester, ET 01, method: 50% elongation for all samples. The method determines the low temperature characteristics by the temperature retraction procedure. The values TR₁₀, TR₃₀, TR₅₀, and TR₇₀ were identified. The TR curves are shown in FIGS. 11A and 11B.

The long chain branching (LCB) of the polymer material in the samples was quantified using Large Amplitude Oscillatory Shear (LAOS) method (Alpha Technologies) and Rubber process Analyzer (RPA) 2000, which uses a bi-cone geometry with a closed die design. The testing temperature was 190° C. Each sample was preheated for 4 minutes, followed by LAOS at 1000% angle. The LCB index was calculated using the following empirical equation that uses LAOS higher harmonic signals:

$$LCB \_ Index = \frac{{S}^{’}}{{S}^{’} 5} - [ \frac{5}{4} + {\frac{1}{4} [ \frac{{S}^{’} 3}{{S}^{’} 5} ]}^{2} - \frac{1}{2} [ \frac{{S}^{’} 3}{{S}^{’} 5} ] ] ,$$

where the S′ is the 1^{st} harmonic value, S′₃ is the 3^{rd} harmonic value, S′₅ is the 5^{th} harmonic value. The greater the positive value, then greater the amount of branching. The same LCB index was also calculated from the modulus values: G′, G′₃, G′₅.

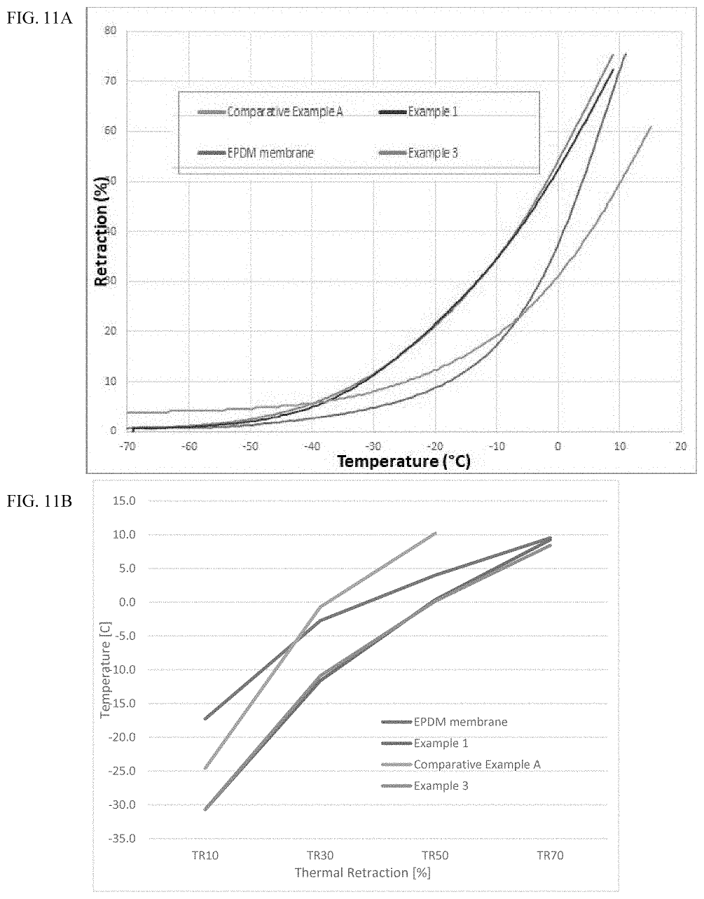

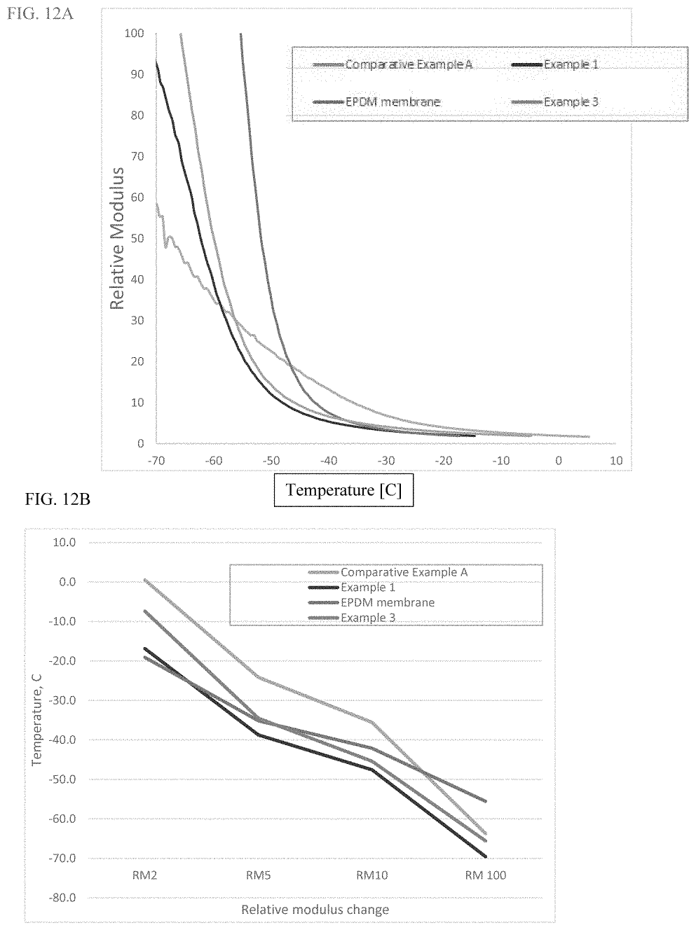

Relative Modulus (RM) was assessed by Gehman testing following ASTM D1053 and Low Temperature Stiffening ISO 1432 testing procedures. Equipment used was Elastocon Gehman-tester, ET 02. Method: Torsional Constant of wire; wire constant: 11.24 for the Comparative Example A and 2.81 for Examples 1, 3 and the EPDM sample. The ISO1432 measures the relative stiffness as a function of the temperature. The result is presented as the relative stiffness where the stiffness in RT is 1. RM results are shown in FIGS. 12A and 12B.

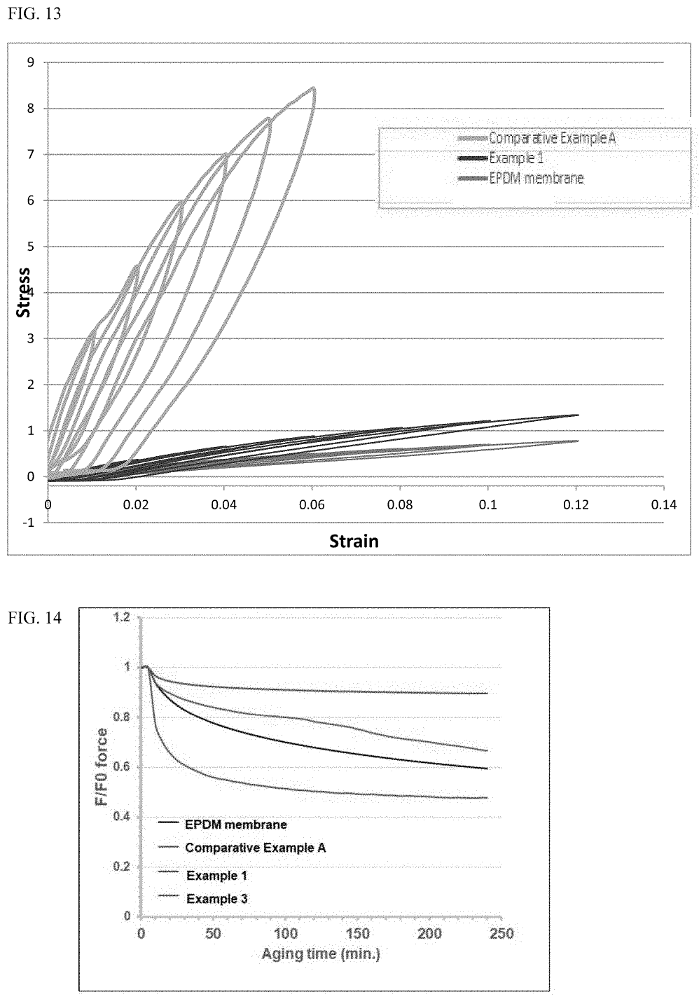

The stress strain curve was also identified for Example 4, Comparative Example A, and the EPDM sample. The Hysteresis loops for the samples are depicted in FIG. 13.

The ageing characteristics of the samples were assessed by several testing methods. The first method was ISO 6914:2004, continuous strain method, which provides assessment for measuring the change of stress in a rubber test piece at a given elongation for the purpose of determining the ageing characteristics of the rubber vulcanizate. The stress relaxation in tension was performed on a dynamic mechanical analysis instrument TA DMA Q800 with 50% strain at 150° C. in air. The testing conditions were as follows: strain ramp 2 mm/min to 50% by at 150° C., followed by 4 hours at temperature of 150° C. in air oven. Specimen: L 10.0±0.1 mm, width 5.0 mm, thickness=plaque thickness (as is 1 mm to 2 mm). ISO 6914 standard recommended thickness is 1 mm. The ageing overlay curves are provided in FIG. 14.

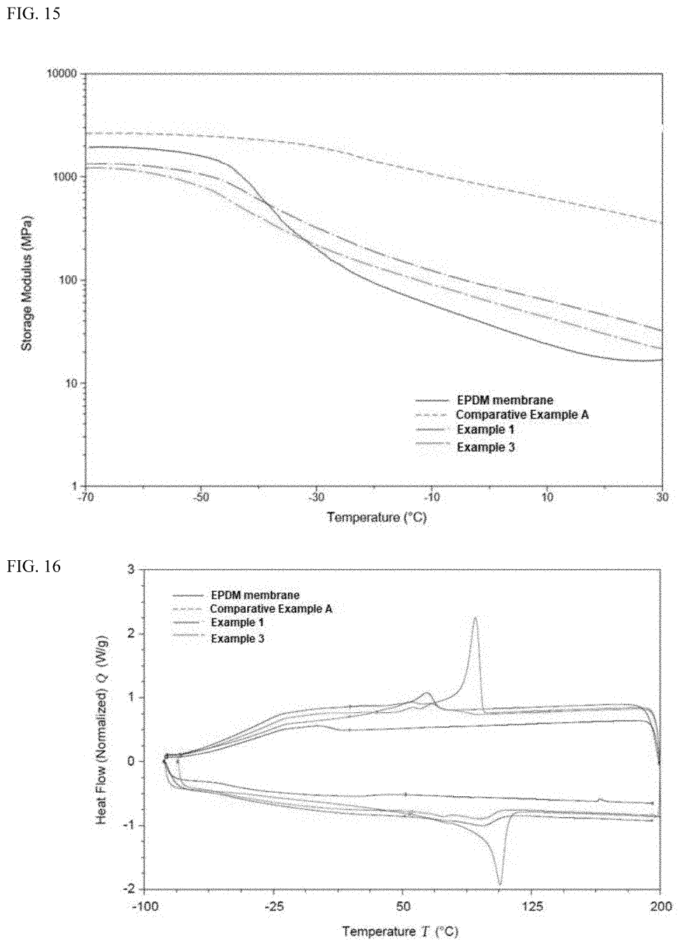

Additional ageing characteristics were assessed using the isothermal temperature testing following the ISO 6914:2004 methodology. The testing was performed using TA DMA Q800, clamp-single cantilever. The testing conditions were as follows: ramp 5° C./min, 1% strain, frequency 1 Hz and temperature range of −70° C. to 30° C. with the ramp rate of 5° C./min. Specimen: cut to L 17.5 mm fixed, width 5.0 mm, thickness=plaque thickness (as is 1.2 to 1.9 mm). The isothermal temperature curve is depicted in FIG. 15.

Crystallinity of the samples was determined using differential scanning calorimeter (DCS) testing provided with TA Discovery DSC 250, Tzero pan, and Tzero lid. DCS testing quantifies heat associated with melting of the polymer. The heat is reported as percent crystallinity by normalizing the observed heat of fusion to that of a 100% crystalline sample of the same polymer. The heat flow rates of the samples were measured against time. Sample weight was 5 to 10 mg cut by razor blade from a plaque having thickness of 1.2 to 1.9 mm. The testing conditions were as follows: 1^{st} heating from room temperature ramp 20° C./min to 200° C. and cooled to about −88° C. and 2^{nd} heating to 200° C., temperature ramp 20° C./min and N₂ gas of 50 ml/min purged. The overlay DSC curves, depicted in FIG. 16, were 1^{st} cooling and 2^{nd} heating curves.

### Examples 7-10

Examples 7-10 were prepared by the same method as Examples 4-6. Each sample was prepared and tested twice. The values in Table 6 are average values.

TABLE 5
Composition of Examples 7-10 in wt. %

| | Example no. | | | | |
|---|---|---|---|---|---|
| | | | | 10 - top | 10- bottom |
| | 7 | 8 | 9 | layer | layer |
| Component | [wt. %] | [wt. %] | [wt. %] | [wt. %] | [wt. %] |
| Ethylene-1-butene copolymer | 35 | 41.75 | 58.45 | 35 | 21.2 |
| ML1 + 4@121° C.: 20 MU, MFR | | | | | |
| (190° C., 2.16 kg): 1.2 g/10 min, | | | | | |
| Density: 0.862 g/cm³, Shore A: 46 | | | | | |
| Ethylene propylene copolymer | 6.5 | — | — | 1.5 | — |
| MFR (230° C., 2.16 kg): 25 g/10 | | | | | |
| min, Density: 0.868 g/cm³, Shore | | | | | |
| A: 84, Total crystallinity: 16% | | | | | |
| Ethylene propylene copolymer | — | 5.0 | 5.7 | 5.0 | — |
| MFR (230° C., 2.16 kg): 25 g/10 | | | | | |
| min, Density: 0.866 g/cm³, Shore | | | | | |
| A: 76-86, Total crystallinity: 18% | | | | | |
| Ethylene-octene copolymers | 12.5 | — | — | 12.5 | — |
| ML1 + 4@121° C.: 10, MFR | | | | | |
| (190° C., 2.16 kg): 3.0 g/10 min, | | | | | |
| Density: 0.902 g/cm³, Shore A: 90, | | | | | |
| Total crystallinity: 29%, Tensile | | | | | |
| strength at break: 22.4 MPa | | | | | |
| Ethylene-1-octene copolymer | — | — | — | — | 20 |
| MFR (190° C., 2.16 kg): 3.0 g/10 | | | | | |
| min, Density: 0.902 g/cm³, Tensile | | | | | |
| strength at break: 64-73 MPa | | | | | |
| Ethylene-octene copolymer | 2.585 | 2.585 | 2.585 | 2.585 | — |
| ML1 + 4@121° C.: 2, MFR (190° C., | | | | | |
| 2.16 kg): 30 g/10 min, Density: | | | | | |
| 0.885 g/cm³, Shore A: 84, Total | | | | | |
| crystallinity: 25%, Tensile strength | | | | | |
| at break: 8.5 MPa | | | | | |
| Ethylene based octene-1 plastomer | — | — | — | — | 5.75 |
| MFR (190° C., 2.16 kg): 3.0 g/10 | | | | | |
| min, Density: 0.883 g/cm³, Shore | | | | | |
| A: 85, Total crystallinity: 25%, | | | | | |
| Tensile strength at break: 22 MPa | | | | | |
| Ethylene-1-butene copolymer | — | — | — | — | 14.5 |
| ML1 + 4/121° C.: 8, MFR (190° C., | | | | | |
| 2.16 kg): 5.0 g/10 min, Density: | | | | | |
| 0.865 g/cm³, Shore A: 54, Tensile | | | | | |
| strength at break: 1.8 MPa | | | | | |
| Polypropylene | — | 7.5 | 10.5 | — | 7.5 |
| MFR (190° C., 2.16 kg): 25 | | | | | |
| Random copolymer of Ethylene | 4.065 | 4.065 | 4.670 | 4.065 | — |
| and Butyl Acrylate | | | | | |
| Butyl Acrylate content of 16-19 | | | | | |
| wt. %; MFR (190° C., 2.16 kg): 6.5- | | | | | |
| 8 g/10 min; Density (23° C.): 0.93 | | | | | |
| g/cm³, Shore A: 88 | | | | | |
| Vinyl silane-peroxide mixture | 1 | — | — | 1 | 1.3 |
| ETOS? | — | 0.75 | 1.125 | — | — |
| Light stabilizer | 1 | 1 | 1.163 | 1 | — |
| Antioxidant | 0.06 | 0.06 | 0.06 | 0.06 | 1.25 |
| Process or secondary stabilizer | 0.021 | 0.021 | 0.075 | 0.021 | 0.25 |
| Acid scavenger and stabilizer for | 0.008 | 0.008 | 0.008 | 0.008 | — |
| Polyolefins | | | | | |
| Slip agent | 0.81 | 0.81 | 0.93 | 0.81 | 2.5 |
| Siloxane masterbatch | 0.9 | 0.9 | 0.93 | 0.9 | — |
| High-purity magnesium hydroxide | 32.50 | 32.50 | 9.75 | 32.50 | — |
| surface treated with a special vinyl | | | | | |
| silane coating | | | | | |
| Titanium dioxide | 3.04 | 3.04 | 3.612 | 3.04 | — |
| Dioctyltin dilaurate | 0.015 | 0.015 | 0.014 | 0.015 | 1.25 |
| Calcium carbonate, small particle | — | — | — | — | 20 |
| size | | | | | |
| Polyethylene based black masterbatch | — | — | — | — | 4.5 |
| Total wt. % | 100 | 100 | 100 | 100 | 100 |

Physical and rheological properties of Examples 7-10 were measured and compared to the same properties of a commercially available TPO roofing membrane sample and a commercially available EPDM roofing membrane sample.

TABLE 6
Physical and mechanical properties of Examples 7-10 in comparison to
a TPO membrane and an EPDM membrane

| | Example no. | | | | | |
|---|---|---|---|---|---|---|
| Measured Property | | | | | TPO membrane | EPDM membrane |
| [unit], Method | 7 | 8 | 9 | 10 | sample | sample |
| Tensile Strength Break | 11.3 | 8.3 | 9.4 | 9.0 | — | 10.4 |
| [MPa], ASTM D412, | | | | | | |
| Die C. | | | | | | |
| Dynamic Puncture | 22.5 | — | 17.5 | — | 27.5 | 15 |
| Resistance, Type I at 5 | | | | | | |
| J, Type II at 10 J, | | | | | | |
| ASTM D5635/D5635M | | | | | | |
| Tensile Elongation, | 918 | 779 | 920 | 819 | — | 448 |
| ultimate, min, [%], | | | | | | |
| ASTM D412, Die C | | | | | | |
| Tear resistance, min, | 45.51 | 40.34 | 38.34 | — | — | 29.63 |
| kN/m [lbf/in.], ASTM | | | | | | |
| D624, Die C | | | | | | |
| Tearing Strength, | 150.73 | 118014 | 114.63 | — | — | 45.57 |
| ASTM D751, B-Tongue | | | | | | |
| Tear | | | | | | |
| Ozone resistance, no | pass | — | pass | — | pass | pass |
| cracks, ASTM D1149 | | | | | | |

Heat ageing: ASTM D573

| | | | | | | |
|---|---|---|---|---|---|---|
| Tensile strength, min, | 9.68 | 7.78 | 10.20 | — | — | 10.98 |
| MPa [psi], ASTM D573 | | | | | | |
| Elongation, ultimate, | 613 | 541 | 671 | — | — | 332 |
| min, [%], ASTM D573 | | | | | | |
| Tear resistance, min, | 43.34 | 35.06 | 35.09 | — | — | 28.87 |
| kN/m [lbf/in.], ASTM | | | | | | |
| D573 | | | | | | |
| Linear dimensional | 1.60 | −0.98 | −0.94 | — | — | 0.38 |
| change, 6 hr 70° C., max, | | | | | | |
| [%], ASTM D573 | | | | | | |
| Water absorption, max, | 0.09 | 0.32 | 0.32 | — | — | — |
| [mass %], ASTM D471, | | | | | | |
| at 70 ± 2° C. [158 6 4° F.] | | | | | | |
| for 166 ± 1.66 h | | | | | | |

Fluid immersion properties: ASTM D471

| | | | | | | |
|---|---|---|---|---|---|---|
| ASTM D471, immersed | −0.2 | — | 0.1 | — | 5.7 | 0.3 |
| 166 hr @ 70° C. in water, | | | | | | |
| [%] | | | | | | |
| ASTM D471, immersed | 6.7 / 7.8 | — | 10.6 / | — | 8.6 / 7.9 | 5.7 / 7.4 |
| 168 hr @ 23° C. in | | | 11.1 | | | |
| animal fat, [mass % / | | | | | | |
| volume %] | | | | | | |
| ASTM D471, immersed | 33.8 / | — | 62 / | — | 32.3 / 37.4 | 55.7 / 81.6 |
| 168 hr @ 23° C. in | 43.8 | | 75.7 | | | |
| compressor oil, [mass % / | | | | | | |
| volume %] | | | | | | |
| ASTM D471, immersed | 97.7 / | — | 232.1 / | — | 101.3 / | 85.5 / |
| 168 hr @ 23° C. in JP8 | 140.6 | | 280.1 | | 134.7 | 165.3 |
| jet fuel, [mass % / | | | | | | |
| volume %] | | | | | | |

Weathering resistance: ASTM G151 and G155

| | | | | | | |
|---|---|---|---|---|---|---|
| Visual inspection, at | no | no | — | — | — | — |
| 2559 KJ | crack or | crack or | | | | |
| | crazing | crazing | | | | |
| Percent Retained | 67 | 80 | — | — | — | — |
| Fractional Strain Energy | | | | | | |
| (PRFSE), min, [%] | | | | | | |
| Elongation, ultimate, | 590 | 662 | — | — | — | — |
| min, [%] | | | | | | |

The above description is considered that of the illustrated embodiments only. Modifications of the device will occur to those skilled in the art and to those who make or use the device. Therefore, it is understood that the embodiments shown in the drawings and described above is merely for illustrative purposes and not intended to limit the scope of the articles, processes and compositions, which are defined by the following claims as interpreted according to the principles of patent law, including the Doctrine of Equivalents.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### LISTING OF NON-LIMITING EXAMPLE EMBODIMENTS

Embodiment A is a roofing membrane comprising: a top layer comprising a flame retardant and a first silane-crosslinked polyolefin elastomer having a density less than 0.90 g/cm³; a scrim layer; and a bottom layer comprising a flame retardant and a second silane-crosslinked polyolefin elastomer having a density less than 0.90 g/cm³, wherein the top and bottom layers of the single ply roofing membrane both exhibit a compression set of from about 5.0% to about 35.0%, as measured according to ASTM D 395 (22 hrs @ 70° C.).

The roofing membrane of Embodiment A wherein the compression set is from about 10% to about 30%.

The roofing membrane of Embodiment A or Embodiment A with any of the intervening features wherein the first and second silane-crosslinked polyolefin elastomers both exhibit a crystallinity of from about 5% to about 25%.

The roofing membrane of Embodiment A or Embodiment A with any of the intervening features wherein the first and second silane-crosslinked polyolefin elastomers have a glass transition temperature of from about −75° C. to about −25° C.

The roofing membrane of Embodiment A or Embodiment A with any of the intervening features wherein the first and second silane-crosslinked polyolefin elastomers each comprise a first polyolefin having a density less than 0.86 g/cm³, a second polyolefin, a silane crosslinker, a grafting initiator, and a condensation catalyst.

The roofing membrane of Embodiment A or Embodiment A with any of the intervening features wherein the density is from about 0.85 g/cm³ to about 0.89 g/cm³.

The roofing membrane of Embodiment A or Embodiment A with any of the intervening features wherein the single ply roofing membrane exhibits a weathering color difference of from about 0.25 ΔE to about 2.0 ΔE, as measured according to ASTM D2244.

The roofing membrane of Embodiment A or Embodiment A with any of the intervening features wherein the first silane-crosslinked polyolefin elastomer and the second silane-crosslinked polyolefin elastomer are chemically distinct from each other.

Embodiment B is a method of making a roofing membrane, the method comprising: extruding a first silane-crosslinkable polyolefin elastomer to form a top layer; extruding a second silane-crosslinkable polyolefin elastomer to form a bottom layer; calendaring a scrim layer between the top and the bottom layers to form an uncured roofing membrane element; and crosslinking the silane-crosslinkable polyolefin elastomers of the top and the bottom layers in the uncured roofing membrane element at a curing temperature and a curing humidity to form the single ply roofing membrane, wherein the top and bottom layers of the single ply roofing membrane both exhibit a compression set of from about 5.0% to about 35.0%, as measured according to ASTM D 395 (22 hrs @ 70° C.).

The method of Embodiment B wherein the first silane-crosslinkable polyolefin elastomer and the second silane-crosslinkable polyolefin elastomer are chemically distinct from each other.

The method of Embodiment B or Embodiment B with any of the intervening features wherein the curing temperature is an ambient temperature.

The method of Embodiment B or Embodiment B with any of the intervening features wherein the curing humidity is an ambient humidity.

The method of Embodiment B or Embodiment B with any of the intervening features wherein the first and second silane-crosslinkable polyolefin elastomers each comprise a first polyolefin having a density less than 0.86 g/cm³, a second polyolefin, a silane crosslinker, a grafting initiator, and a condensation catalyst.

The method of Embodiment B or Embodiment B with any of the intervening features wherein the single ply roofing membrane exhibits a weathering color difference of from about 0.25 ΔE to about 2.0 ΔE, as measured according to ASTM D2244.

The method of Embodiment B or Embodiment B with any of the intervening features wherein the single ply roofing membrane exhibits a flame retardance rating of classification D as measured in accordance with the EN ISO 11925-2 surface exposure test.

Embodiment C is a method of making a high-load flame retardant thermoplastic polyolefin (TPO) roofing membrane, the method comprising: adding a silane-grafted polyolefin elastomer, a flame retardant, and a condensation catalyst to a reactive single screw extruder to produce a silane-crosslinkable polyolefin elastomer; calendaring the silane-crosslinkable polyolefin elastomer to form a top layer and a bottom layer; calendaring a scrim layer between the top and the bottom layers to form an uncured roofing membrane element; and crosslinking the silane-crosslinkable polyolefin elastomers of the top and the bottom layers in the uncured roofing membrane element at an ambient temperature and an ambient humidity to form the thermoplastic polyolefin (TPO) roofing membrane, wherein the top and bottom layers of the thermoplastic polyolefin (TPO) roofing membrane both exhibit a compression set of from about 5.0% to about 35.0%, as measured according to ASTM D 395 (22 hrs @ 70° C.).

The method of Embodiment C wherein the top and bottom layers are chemically equivalent to each other.

The method of Embodiment C or Embodiment C with any of the intervening features wherein the single ply roofing membrane exhibits a flame retardance rating of classification D as measured in accordance with the EN ISO 11925-2 surface exposure test.

The method of Embodiment C or Embodiment C with any of the intervening features wherein the silane-grafted polyolefin elastomer comprises a first polyolefin having a density less than 0.86 g/cm³, a second polyolefin, a silane crosslinker, a grafting initiator.

The method of Embodiment C or Embodiment C with any of the intervening features wherein the high-load flame retardant thermoplastic polyolefin (TPO) roofing membrane exhibits a weathering color difference of from about 0.25 ΔE to about 2.0 ΔE, as measured according to ASTM D2244.

What is claimed is:

1. A roofing membrane comprising:
(A) about 40 to 75 wt. % silane-crosslinked polyolefin elastomer/plastomer component including a blend of at least three different polyolefin elastomers, each having different melt mass-flow rate (MFR), measured at 190° C. under a 2.16 kg load, in a range of about 3.0 to 25.0 g/10 min,
(E) about 1 to 20 wt. % functional filler(s) including a polyolefin;
(F) UV/heat stabilizer(s);
(G) antioxidant(s); and
(H) fire retardant(s),
wt. % based on the total weight of the roofing membrane.

2. The roofing membrane of claim 1, wherein the blend of the at least three different polyolefin elastomers includes a first polyolefin, a second polyolefin, and a third polyolefin in a ratio of first polyolefin:second polyolefin:third polyolefin of about 16.2:1:2.

3. The roofing membrane of claim 1, wherein the blend of the at least three different polyolefin elastomers includes two different ethylene-octene copolymers.

4. The roofing membrane of claim 1, wherein the component A includes different amounts of each one of the at least three different polyolefin elastomers.

5. The roofing membrane of claim 1, wherein the component (E) comprises polypropylene having MFR in the same range as the polyolefin elastomers of the component (A).

6. The roofing membrane of claim 1, wherein the membrane exhibits a glass transition temperature of from about −75° C. to about −25° C., measured according to differential scanning calorimetry (DSC) using a second heating run at a rate of 5° C./min or 10° C./min.

7. The roofing membrane of claim 1, wherein the membrane exhibits low temperature retraction in a range of about −35 to −29% at TR10, measured according to ISO 2921.

8. A roofing membrane comprising:
a top layer having a thickness t₁ and including:
a first (A) silane-crosslinked polyolefin elastomer/plastomer component including a first blend of at least three polyolefin elastomers, each having different melt mass-flow rate (MFR), measured at 190° C. under a 2.16 kg load, and
a bottom layer having a thickness t₂ and including:
a second (A) silane-crosslinked polyolefin elastomer/plastomer component including a second blend of polyolefin elastomers,
the thickness t₂ being greater than the thickness t₁.

9. The roofing membrane of claim 8, wherein at least one of the second blend of polyolefin elastomers is the same elastomer as in the first blend.

10. The roofing membrane of claim 8, wherein a ratio of the first silane-crosslinked polyolefin elastomer/plastomer second silane-crosslinked polyolefin elastomer/plastomer is about 19:1 to 2:1.

11. The roofing membrane of claim 8, wherein the top layer further comprises (F) UV/heat stabilizer(s) and both the top and bottom layers further comprise (G) antioxidant(s) and (H) fire retardant(s).

12. The roofing membrane of claim 8, wherein the top layer further includes titanium dioxide, and the bottom layer is titanium dioxide-free.

13. The roofing membrane of claim 8, wherein the first and second silane-crosslinked polyolefin elastomer/plastomer components include a same polyolefin, the polyolefin being present in a lower weight percentage in the bottom layer than in the top layer.

14. The roofing membrane of claim 8, wherein the first blend includes a first polyolefin, a second polyolefin, and a third polyolefin in a ratio of first polyolefin:second polyolefin:third polyolefin of about 16.2:1:2.

15. The roofing membrane of claim 8, wherein the top layer has a gel content greater than about 70% and the bottom layer may have a gel content between about 50 and 70%.

16. A roofing membrane comprising:
a single-ply layer including:
a silane-crosslinked polyolefin elastomer/plastomer component comprising a blend of ethylene-1-butene copolymer, ethylene propylene copolymer, and ethylene octene copolymer; and
one or more UV/heat stabilizer(s), antioxidant(s), and fire retardant(s),
the single-ply layer having elongation at break, measured according to ASTM D412, Die C, of about 600 to 930% and heat ageing elongation at break, measured according to the ASTM D573, of about 350 to 700%.

17. The roofing membrane of claim 16, wherein a ratio of the ethylene-1-butene copolymer:ethylene propylene copolymer:ethylene octene copolymer is about 5.4:1:2.

18. The roofing membrane of claim 16, wherein the component (A) includes different amounts of the ethylene-1-butene copolymer, ethylene propylene copolymer, and ethylene octene copolymer.

19. The roofing membrane of claim 16, wherein the single-ply layer further comprises polypropylene having MFR in the same range as at least one of the ethylene-1-butene copolymer:ethylene propylene copolymer:ethylene octene copolymer.

20. The roofing membrane of claim 16, wherein the roofing membrane has tensile elongation at break, measured according to ASTM D412, Die C testing method, of about 600 to 930%.
